(19) United States
(12) Patent Application Publication
(10) Pub. No.: US 2011/0236025 A1
(43) Pub. Date: Sep. 29, 2011

(54) SUB-RATE SAMPLING IN COHERENT OPTICAL RECEIVERS

(75) Inventors: Andrew Wagner, Los Altos, CA (US); Christian Malouin, San Jose, CA (US); Theodore J. Schmidt, Gilroy, CA (US)

(73) Assignee: OPNEXT SUBSYSTEMS, INC., Los Gatos, CA (US)

(21) Appl. No.: 13/072,629

(22) Filed: Mar. 25, 2011

Related U.S. Application Data
(60) Provisional application No. 61/317,627, filed on Mar. 25, 2010.

(51) Int. Cl. H04B 10/06

(52) U.S. Cl. 398/115; 398/209

(57) ABSTRACT

Apparatus and methods for optimizing the interplay between the sampling rate of an ADC of a receiver system and a bandwidth of analog anti-aliasing filters are described. The described technology can be used to mitigate aliasing for receiver systems that operate at fractional sampling rates by optimizing a bandwidth of optical and electrical filters included in the receiver systems.

### PRIORITY CLAIM AND RELATED APPLICATIONS

This application claims the benefits of the U.S. Provisional Application No. 61/317,627 entitled “Optical Communications Based On Optical Receivers Having Fractional Sampling” and filed Mar. 25, 2010, which is incorporated herein by reference in its entirety.

### TECHNICAL FIELD

This patent document relates to apparatus, systems and techniques for optical communications.

### BACKGROUND

Polarization-multiplexed quadrature phase shift keying (PM-QPSK) with coherent detection is a leading modulation format for single-carrier 100 Gb/s long-haul transport. Digital signal processing (DSP) in such a communication system can be enabled by analog-to-digital converters (ADC) sampling the signal at high speed. These digital samples are then subsequently processed to compensate for linear impairments like chromatic dispersion (CD) and polarization mode dispersion (PMD). It is commonly expected that the sampling rate of the ADC must be 2 Rs or greater where Rs is the symbol rate. Assuming 20.5% forward-error correction (FEC) coding over-head, the total line rate for such a FEC is 126.5 Gb/s giving Rs=31.6 Gbaud/s. For this case, the required ADC sampling is ≧63 GSamples/s. This rate is challenging for state of the art ADCs based in SiGe or CMOS. In order to lower the requirement on the ADC speed, the sampling can be performed at the symbol rate Rs. A symbol rate equalizer can be used for Rs sampling, but such an equalizer requires an external error signal to find the best sampling phase and can be sensitive to aliasing. In this case, an optical signal-to-noise ratio (OSNR) penalty of 1.5 dB may occur for a CD of order 500 ps/nm. Alternatively, a rational over-sampling rate of M/K may be used, where M is a quantity of filter taps, K is a number of filter banks, and M>K. The rational over-sampling equalizer does not need a closed time sampling loop but does require multiple (K) filter banks.

### SUMMARY

This document describes apparatus and methods for optimizing the interplay between the sampling rate of an ADC of a receiver system and a bandwidth of analog anti-aliasing filters. The disclosed technology can be used to mitigate aliasing for receiver systems that operate at multiple sampling rates, e.g. 1, 2 or 3/2×Rs, by optimizing a bandwidth of optical and electrical filters that can be included in the receiver systems.

The apparatus and methods described in this document can be implemented to achieve one or more potential benefits. For example, analog-to-digital conversion can be less than two times the rate of the incoming symbols. For instance, the disclosed technology can limit a performance penalty of the receiver system to no more than 0.5 dB down to a sampling rate of 1.25×, even when the CD is as large as 23,000 ps/nm. In addition, the reduced sampling rate enables receiver configurations with low gate count, and consequently, for use in receivers characterized by low power dissipation.

Further, analog impairment recovery can be performed at a digital rate lower than two times the symbol rate. Furthermore, analog-to-digital conversion can be free running with respect to the symbol rate. Additionally, analog-to-digital conversion may be independent of the symbol rate. Also, data estimation can be performed at a different rate than the analog-to-digital conversion. In addition, timing error detection can be performed at a different rate than either the analog-to-digital conversion or the data estimation.

These and other aspects and their implementations are described in greater detail in the drawings, the description and the claims.

### BRIEF DESCRIPTIONS OF THE DRAWINGS

FIG. 1 is a block diagram of an example of an optical receiver having a fractional sampling analog-to-digital converter and a timing recovery interpolation synchronizer.

FIG. 2 is block diagram of an example of the interpolation synchronizer of FIG. 1.

FIG. 3 is a diagram of a numerical example for the interpolation synchronizer of FIG. 2.

FIG. 4 is a flow chart of an example of a method for processing an optical signal with fractional sampling analog-to-digital conversion and timing recovery interpolation synchronization.

FIG. 5 is a first flow chart for an example of the interpolation synchronization in the method of FIG. 4.

FIG. 6 is a second flow chart for an example of the interpolation synchronization in the method of FIG. 4.

FIG. 7 is a flow chart for an example of digital clocking control in the method of FIG. 4.

FIG. 8 is a block diagram of an example of the interpolation synchronizer of FIG. 1 having two stage interpolation.

FIGS. 9A and 9B are alternative block diagrams of an example of the FIFO operation for the interpolation synchronizers of FIGS. 2 and 8.

FIG. 10 is a block diagram of an example of a 100G PM-QPSK communications system.

FIG. 11 shows a qualitative representation of aliasing effects with and without using an anti-aliasing filter.

FIG. 12 shows a block diagram of an example of an analog-to-digital converter.

FIG. 13A-13B shows aspects related to an example of a symbol rate equalizer.

FIG. 13C shows a block diagram of an example of a fractionally spaced equalizer.

FIG. 14 shows a block diagram of an example of a receiver system.

FIG. 15A-15C show block diagrams of an example of a communications system.

FIG. 16 shows SNR penalty as a function of relative ADC sampling rate and electrical analog bandwidth of an anti-aliasing filtering scheme.

FIG. 17A shows a block diagram of an example of a communications system.

FIG. 17B shows a block diagram of another example of a communications system.

FIG. 18 shows results of experiments performed using the communication system illustrated in FIGS. 15A-15C.

### DETAILED DESCRIPTION

This document describes systems and techniques for mitigating aliasing effects caused by lowering analog-to-digital (ADC) sampling frequency in a modem (receiver system) configured to operate in a polarization multiplexed-QPSK based optical communications system. More specifically, the disclosed techniques can be used to optimize characteristics of electrical and optical filters configured to obtain a target performance for receiver systems operating at sampling frequencies that are less than 2× the symbol rate of the received signals. In addition, the use of the described technologies enables obtaining the target performance for receiver systems having low gate count, and thus low power dissipation.

This document further describes examples and implementations for apparatus and methods having fractional sampling analog-to-digital (ADC) conversion and interpolation timing recovery synchronization. The ADC conversion may have a free running rate that is independent of the symbol rate of the incoming signal. The ADC conversion rate may be, but is not necessarily, a fraction of the expected symbol rate between one and two times the symbol rate. In some implementations, the fractional ADC conversion rate may be between one and two times the expected symbol rate (baud rate). Digital values are derived from the ADC conversion output samples. Sequential digital values are interpolated to calculate values of moving interpolations. The moving interpolations are calculated temporally between the digital values at interpolation clock sample times that are moving with respect to the ADC clock sample times of the digital values. The moving interpolations are performed at a rate that can be different than the fractional sampling rate of the ADC. Timing recovery is performed on the moving interpolations to synchronize to the incoming signal symbols.

It should be understood that it is not necessary to employ all of the technical details of the features that are described herein. Further, the described technical details may be mixed and matched for a particular implementation based on the specific requirements of the implementation.

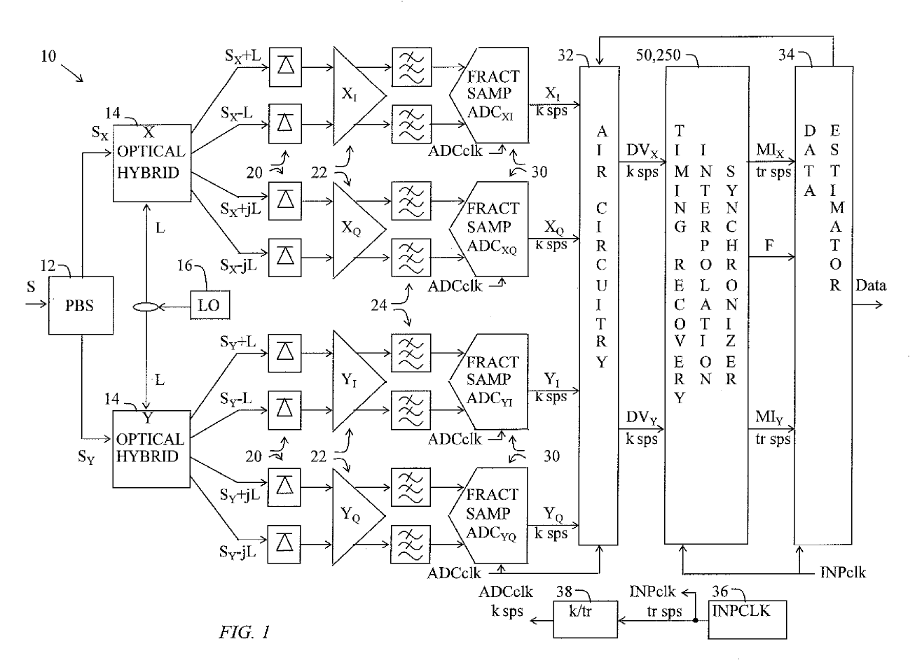

FIG. 1 is a block diagram of an example of an optical receiver 10. The receiver 10 is a specific implementation of an optical receiver for receiving an incoming optical signal carrying symbols that includes an optical polarization beam splitter at the input. This optical polarization beam splitter receives an incoming optical signal carrying symbols and splits the incoming optical signal into a first optical signal carrying the symbols and being in a first optical polarization and a second optical signal carrying the symbols and being in a second optical polarization that is orthogonal to the first optical polarization. A first optical device is provided to receive the first optical signal and an optical local oscillator signal and produce first hybrid output optical signals that are different from one another. Each first hybrid output optical signal is generated by mixing the first optical signal and the local optical oscillator signal. First optical detectors are provided to receive the first hybrid output optical signals, respectively, and produce first analog electrical baseband signals. Similarly, a second optical device is provided to receive the second optical signal and the optical local oscillator signal and produce second hybrid output optical signals that are different from one another where each second hybrid output optical signal is generated by mixing the second optical signal and the local optical oscillator signal; and second optical detectors are provided to receive the second hybrid output optical signals, respectively, and produce second analog electrical baseband signals. In addition, a signal processing circuit is provided for fractional analog-to-digital conversion sampling and interpolation timing recovery. This signal processing circuit receives the first analog electrical baseband signals and the second analog electrical baseband signals and outputs the symbols carried by the incoming optical signal. The signal processing circuit includes means for converting an analog signal carrying the symbols to digital output samples at a fractional sampling clock rate; means for interpolating at an interpolation clock rate different than the fractional sampling clock rate between digital values derived from the digital output samples to provide moving interpolations; and means for synchronizing the moving interpolations with the symbols.

Referring now to FIG. 1, the optical receiver 10 receives an incoming optical signal S through an optical channel from an optical transmitter. The incoming optical signal S carries modulation where modulation states represent symbols and the symbols represent one or more bits of data. The receiver 10 may be constructed for binary phase shift key (BPSK), quaternary phase shift key (QPSK), quadrature amplitude modulation (QAM), orthogonal frequency division multiplexing (OFDM), one of these formats with optical polarization mixing, a combination of these formats, or other modulations.

The optical receiver 10 includes a polarization beam splitter (PBS) 12 that receives input light and outputs a first optical output in a first optical polarization and a second optical output in a second optical polarization that is orthogonal to the first optical polarization. In some implementations, the polarization beam splitter 12 may be implemented to include a diversity optical mixer and an optical downconverter. The receiver 10 also includes X and Y optical hybrids 14, an optical local oscillator (LO) 16, optical detectors 20, electrical signal amplifiers 22, electrical anti-aliasing filters 24, fractional sampling analog-to-digital converters (ADC's) 30, analog impairment recovery (AIR) circuitry 32, a timing recovery interpolation synchronizer 50 or 250, and a data estimator 34. The interpolation synchronizer 50,250 performs timing recovery and synchronizes to the symbols carried on the incoming optical signal S. The interpolation synchronizer 50,250 changes the signal sample rate from the ADC sample rate to the sample rate needed by the data estimator 34. The interpolation synchronizer 50,250 may change the sample rate from an ADC sample rate that is less than two times the symbol rate to a sample rate that is equal to or greater than two times the symbol rate for timing error detection and/or data estimation.

The polarization beam splitter 12 separates mutually orthogonally polarizations of the incoming optical signal S, e.g., horizontal and vertical polarizations, into an optical signal S_{X} for horizontal polarization states of the incoming optical signal S and optical signal S_{Y} for vertical polarization states of the incoming optical signal S. The PBS 12 passes the horizontal and vertical optical signals S_{X} and S_{Y} to the X and Y optical hybrids 14, respectively.

The local oscillator 16 generates an optical local oscillator (LO) signal L. The X and Y optical hybrids 14 mix the incoming optical signals S_{X} and S_{Y} with the local oscillator signal L to generate hybrid output optical signals. In implementations, the X and Y hybrids 14 can be 90° 8-port devices having four input port and four output port. In the illustrated example, two of the four inputs are used for receiving the optical output from the PBS 12 and the optical local oscillator signal L, respectively and two inputs not used. The 8-port X hybrid 14 outputs four hybrid output optical signals in an X signal path and the 8 port Y hybrid 14 outputs four hybrid output optical signals in a Y signal path. The hybrid output optical signals from the X hybrid 14 are the sums and differences of the optical signal S_{X} and the real and imaginary local optical signal L and jL. The hybrid output optical signals from the Y hybrid 14 are the sums and differences of the optical signal S_{Y} and the real and imaginary local optical signal L and jL.

The X optical hybrid 14 mixes the incoming horizontal signal S_{X} with the local oscillator signal L to generate an optical signal S_{X}+L for the sum of the incoming horizontal signal S_{X} and the real local oscillator signal L, an optical signal S_{X}−L for the difference of the incoming horizontal signal S_{X} and the real local oscillator signal L, an optical signal S_{X}+jL for the sum of the incoming horizontal signal S_{X} and the imaginary local oscillator signal jL, and an optical signal S_{X}−jL for the difference of the incoming horizontal signal S_{X} and the imaginary local oscillator signal jL.

Similarly, the Y optical hybrid 14 mixes the incoming vertical optical signal S_{Y} with the local oscillator signal L to generate an optical signal S_{Y}+L for the sum of the incoming vertical signal S_{Y} and the real local oscillator signal L, an optical signal S_{Y}−L for the difference of the incoming vertical signal S_{Y} and the real local oscillator signal L, an optical signal S_{Y}+jL for the sum of the incoming vertical signal S_{Y} and the imaginary local oscillator signal jL, and an optical signal S_{Y}−jL for the difference of the incoming vertical signal S_{Y} and the imaginary local oscillator signal jL.

The detectors 20 detect the hybrid output optical signals to provide respective electrical baseband signals. In an implementation, the detectors can be square law photo diodes. The baseband signals have beating amplitudes proportional to the amplitudes and phases of the modulations of the optical signals S_{X} and S_{Y}. The detectors 20 pass the baseband signals to the amplifiers 22. The baseband signals are proportional to |S_{X}+L|² and |S_{X}−L|² in an X_{I} path, proportional to |S_{X}+jL|² and |S_{X}−jL|² in an X_{Q} path, proportional to |S_{Y}+L|² and |S_{Y}−L|² in a Y_{I} path and proportional to |S_{Y}+jL|² and |S_{Y}−jL|² in a Y_{Q} path. In another implementation the X and Y hybrids 14 are 6-port (three input port and three output port) devices for detection of single-sided hybrid output optical signals. While balanced detection is used to cancel out the contribution of the local oscillator signal L, single-sided detection can also be used.

An X_{I} amplifier 22 amplifies the electrical |S_{X}+L|² and |S_{X}−L|² signals. An X_{Q} amplifier 22 amplifies the electrical |S_{X}+jL|² and |S_{X}−jL|² signals. A Y₁ amplifier 22 amplifies the electrical |S_{Y}+L|² and |S_{Y}−L|² signals. A Y_{Q} amplifier 22 amplifies the electrical |S_{Y}+jL|² and |S_{Y}−jL|² signals. The amplifiers 22 pass the amplified electrical signals as analog signals to the fractional sampling analog-to-digital converters (ADC's) 30.

Anti-aliasing filters 24 before or at the input of the fractional sampling ADC's 30 are positioned in the signal paths to reduce aliasing effects.

An ADC_{XI} 30 converts the analog signal (|S_{X}+L|²−|S_{X}−L|²) to digital ADC output samples X_{I}. An ADC_{XQ} 30 converts the analog signal (S_{X}+jL|²−|S_{X}−jL|²) to digital ADC output samples X_{Q}. An ADC_{YI} 30 converts the analog signal (|S_{Y}+L|²−|S_{Y}−L|²) to digital ADC output samples Y_{I}. An ADC_{YQ} 30 converts the analog signal (|S_{Y}+jL|²−|S_{Y}−jL|²) to digital ADC output samples Y_{Q}. In another implementation, the amplifiers 22 generate single sided signals to the ADC's 30. It should be noted at this point that the modulation for the symbols that was carried by the incoming optical signal S continues to be carried in a representative way on the amplitudes of the values of the ADC output samples. The ADC's 30 pass the ADC output samples to the analog impairment recovery (AIR) circuitry 32.

The AIR circuitry 32 performs digital corrections on the ADC output samples X_{I} and X_{Q} to compensate for analog impairments to the optical signal S caused by imperfections in the optical transmitter, optical channel, optical modules in the front end of the receiver 10 and electrical components up to the AIR circuitry 32. The corrections are sometimes called IQ corrections. The performance of the AIR circuitry 32 for IQ corrections may be aided by feedback from the data estimator 34. The corrected ADC output samples are generated as digital values DV_{X} in the X signal path and digital values DV_{T} in the Y signal path.

The digital values DV_{X} and DV_{T} may be implemented as complex numbers where one portion of a word for the digital value carries an I (in-phase) value and another portion of the word carries a Q (quadrature-phase) value, i.e. a DV is I+jQ. The sequences of the digital values DV_{X} and DV_{T} continue to carry modulation on their amplitude values that represents the signal symbols carried in the incoming signal S but corrected for estimates of impairments to more closely resemble the symbols that were intended to be transmitted. The AIR circuitry 32 passes the digital values DV_{X} and DV_{T} to the interpolation synchronizer 50,250.

The interpolation synchronizer 50,250 interpolates between successive digital values DV_{X} to determine values for moving interpolations MI_{X}; and interpolates between successive digital values DV_{T} to determine values for moving interpolations MI_{T}. The values for the moving interpolations MI_{X} and MI_{T} may be carried as complex numbers of I and Q.

The timing of the moving interpolations MI_{X} and MI_{T} is synchronized to the timing of the symbols by the interpolation synchronizer 50,250. The interpolation synchronizer 50,250 passes the synchronized moving interpolations MI_{X} and MI_{T} to the data estimator 34.

The data estimator 34 includes equalizers, demodulators, decoders, coders, and error detection and correction circuitry to process the values of the moving interpolations MI_{X} and MI_{T} in order to estimate the data that was actually transmitted or intended to be transmitted by the transmitter.

The receiver 10 includes an interpolation clock (INPCLK) 36 and a fractional sampling divider 38. The INPCLK 36 provides an interpolation clock signal INPclk at a free running interpolation clock rate. The fractional sampling divider 38 frequency divides the interpolation clock signal INPclk to provide an ADC clock signal (ADCclk) at a fractional sampling clock rate. The interpolation clock signal INPclk and the fractional sampling clock signal ADCclk are not required to be synchronized to the symbols. The interpolation clock rate is nominally tr times the expected symbol rate (tr sps) where tr is a selected multiple and the abbreviation sps stands for samples per symbol. In some implementations, the interpolation clock rate is slightly greater than tr sps. In some implementations, the fractional sampling clock rate is a fraction between one-half and one times tr sps. In some implementations, the selected multiple tr is two. In this implementation the interpolation clock rate is nominally (or slightly greater than) two samples per symbol and the fractional sampling clock rate is nominally between one and two samples per symbol. The true symbol rate, at the selected multiple tr, is recovered by the interpolation synchronizer 50,250.

The fractional sampling divider 38 frequency divides the INPclk by tr/k. This effectively multiplies the frequency of the INPclk signal by k/tr to provide the fractional sampling clock signal ADCclk, where k is a sampling rate fraction. The ADCclk signal may operate the ADC's 30 to provide the ADC output samples X_{I}, X_{Q}, Y_{I} and Y_{Q} at the sampling rate fraction k times an expected symbol rate. In one implementation, the sampling rate fraction k is in the range between one and two. In some implementations, the sampling rate fraction k is 5/4. The ADC's 30 use the fractional sampling ADCclk signal to sample the analog signals from the amplifiers 22 and anti-aliasing filters 24 to provide the streams of ADC output samples X_{I}, X_{Q}, Y_{I}, Y_{Q}.

Several hardware analog-to-digital converters may operate in parallel for each of the ADC_{XI} 30, ADC_{XQ} 30, ADC_{YI} 30, and ADC_{XQ} 30. For example, ADC_{XI} 30 would have several analog-to-digital converters operating in parallel and so on for ADC_{XQ} 30, ADC_{YI} 30, and ADC_{XQ} 30. In this implementation, each of the parallel analog-to-digital converter samples the analog signal at a sample rate that is divided by the number of parallel analog-to-digital converters. For example, in one implementation, 128 analog-to-digital converters are operated in parallel for each of the ADC_{XI} 30, ADC_{XQ} 30, ADC_{YI} 30, and ADC_{XQ} 30. In this case, each analog-to-digital converter samples the analog signal at a nominal rate of k/128 sps to effectively provide the ADC output samples X_{I}, X_{Q}, Y_{I}, and Y_{Q} at a nominal rate of k sps.

The AIR circuitry 32 operates with the ADCclk signal to process the ADC output samples X_{I}, X_{Q}, Y_{I}, and Y_{Q} to provide the digital values DV_{X} and DV_{Y}. In one implementation, the AIR circuitry 32 receives the ADC output samples as separate I and Q streams for the optical S_{X} polarity and separate I and Q streams for the optical S_{Y} polarity (or several parallel streams for X_{I}, several parallel streams for X_{Q}, several parallel streams for Y_{I}, several parallel streams for Y_{Q}) and generates digital values DV_{X} and DV_{Y} as separate streams having complex IQ (or several parallel streams for DV_{X} complex IQ and several parallel streams for DV_{Y} complex IQ). In some implementations, the complex IQ is carried by the I information being allocated certain bit positions in an IQ word and the Q information being allocated other bit positions in the IQ word. The effective output rates of the digital values DV_{X} and DV_{Y} from the AIR circuitry 32 is nominally k sps.

The sequences of the ADC output samples X_{I}, X_{Q}, Y_{I} and Y_{Q} and the sequences of the digital values DV_{X} and DV_{Y} are free running, not synchronized to the symbol rate. The interpolation synchronizer 50,250 passes an inhibitor flag F to the data estimator 34 in order to bring the average rate of the INPclk signal to tr sps and to control the digital clocking operation of the data estimator 34 to tr sps as viewed in the data domain.

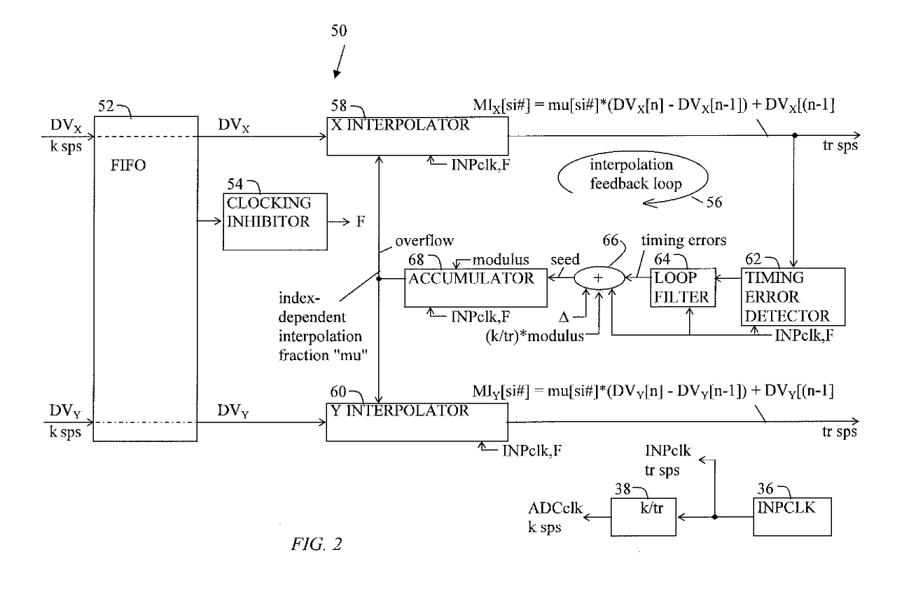

FIG. 2 is block diagram of an example of the interpolation synchronizer 50 for the optical receiver 10. The interpolation synchronizer 50 includes a first in first out memory (FIFO) 52, a clocking inhibitor 54, and an interpolation feedback loop 56 including an X interpolator 58. The interpolation synchronizer 50 also includes a Y interpolator 60.

The interpolation feedback loop 56 includes the X interpolator 58, a timing error detector 62, a loop filter 64, a seed generator 66, and an accumulator 68. In some implementations, the sampling rate fraction k is between one and two; the INPclk has a clock rate slightly greater than two samples per second; and the interpolation synchronizer 50 provides moving interpolation values MI_{X} and MI_{Y} at two samples per symbol. The X and Y interpolators 58 and 60 are configured as horizontal and vertical polarization interpolators, corresponding to optical signals S_{X} and S_{Y}, respectively. Only the X interpolator 58 is required when the optical signal S has only one polarization.

The AIR circuitry 32 writes the digital values DV_{X} and DV_{Y} into the FIFO 52 with the ADCclk signal. The X and Y interpolators 58 and 60 read the digital values DV_{X} and DV_{Y}, respectively, from the FIFO 52 on a first in first out basis at overflows of the accumulator 68. Occasionally, reading the FIFO 52 at a faster rate than writing into the FIFO 52 causes the number of stored values in the FIFO 52 to fall below a selected threshold. The terms “empty”, “not valid” and “invalid” are used herein to designate a condition where the number of the digital values in the FIFO 52 is less than this threshold, and the terms “filled”, “full” and “valid” are used herein to describe a condition where the number of digital values in the FIFO 52 is greater than this threshold. When the FIFO 52 is empty, the clocking inhibitor 54 sets the inhibitor flag F (also called the FIFO flag F) to indicate that the FIFO 52 is not valid. When the FIFO 52 is full, the clocking inhibitor 54 sets the flag F to indicate that the FIFO 52 is valid.

The elements of the interpolation feedback loop 56 and the Y interpolator 60 are clocked by the interpolation clock signal INPclk. The flag F controls the digital clocking operation of the signal INPclk for the interpolation synchronizer circuitry 50. When the FIFO 52 is not valid the clocking inhibitor 54 stops or freezes the interpolation clock signal INPclk, or stops or freezes the circuitry in the interpolation synchronizer 50 so that the circuitry does not respond to the interpolation clock signal INPclk. The FIFO flag F is set to valid when a new set of digital values DV_{X} and DV_{Y} are written into the FIFO 52 and the number of stored values fills above the threshold. When the FIFO 52 is valid, the clocking by the interpolation clock signal INPclk resumes.

An effect of the flag F is to bring the average rate of the interpolation clock signal INPclk to tr sps and to control the digital clocking of the interpolation synchronization circuitry 50 to tr sps as viewed in the data domain. In one implementation, the inhibitor flag F acts to swallow an occasional extra cycle in the interpolation clock signal INPclk. The inhibitor flag F acts to synchronize the free running (as visualized in the time domain with an oscilloscope) interpolation clock signal INPclk to tr sps (as visualized in the data domain with a data analyzer).

The timing error detector 62 detects timing errors between the timing of the moving interpolations MI_{X} and the timing of the symbols carried by the values of moving interpolations MI_{X} in order to provide values for timing errors. The timing error detector 62 can use an early-late technique, a Gardener algorithm, and/or a Mueller Muller algorithm. The loop filter 64 filters the values and provides filtered timing error values to the seed generator 66. The seed generator 66 calculates a seed value from the sum of the timing error value and an offset value. The offset value is based on a fractional clock ratio between the ADC clock rate and the interpolation clock rate. In some implementations, the fractional clock ratio is k/tr times (scaled by) a modulus (maximum output value) of the accumulator 68. The offset value may also include an overflow rate compensation Δ. The overflow rate compensation Δ can be used to mitigate a difference between the interpolation clock rate and the desired tr sps in order to bias the overflow rate of the accumulator 68 to reduce the frequency of occurrence for the FIFO 52 to become empty.

The seed generator 66 provides the seed values to the accumulator 68. The accumulator 68 has an output value having a maximum output value set by its modulus. The accumulator 68 increments its current output value by each new seed value to provide a new output value. An overflow occurs when the addition of the new seed causes the new output to exceed the modulus. An overflow by the accumulator 68 causes the X and Y interpolators 58 and 60 to read the next digital values DV_{X} and DV_{T}, respectively, from the FIFO 52.

The output value of the accumulator 68 is an index-dependent interpolation fraction referred to as mu. The fraction mu is used by the X interpolator 58 to interpolate between sequential digital values DV_{X} from the FIFO 52. The same interpolation fraction mu is used at the same time by the Y interpolator to interpolate between sequential digital values DV_{Y} from the FIFO 52.

The X and Y interpolators 58 and 60 interpolate between a most recent [n] and a second most recent [n−1] previous digital value in order to provide the values of the moving interpolations MI_{X} and MI_{T}, respectively, according to Equation 1 below:

MI[si#]=mu[si#]*(DV[n]−DV[n−1])+DV[n−1] (1)

In the equation 1, si# is an index for the interpolation fraction mu and n is an index for the digital values DV_{X} and DV_{T}. The interpolation fraction mu[si#] is provided by the accumulator 68 according to Equation 2 below:

mu[si#]=si#*(k/tr)modulo1 (2)

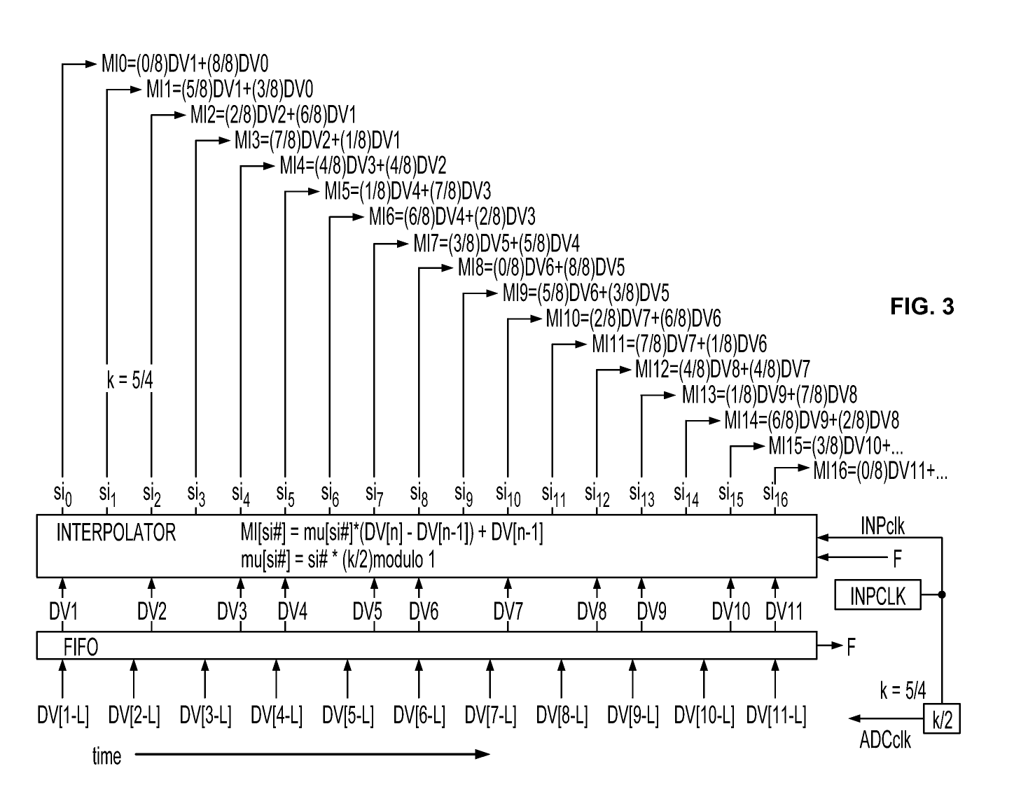

FIG. 3 shows a numerical example for the calculations performed by the X and Y interpolators 58 and 60 to interpolate the digital values DV_{X} and DV_{T} to calculate the moving interpolations MI_{X} and MI_{T}, respectively, according to the equations 1 and 2 where tr equals two.

The numerical example applies to both the X and Y interpolators 58 and 60. In the example, the calculations are shown for an operational sampling rate fraction k= 5/4 and a selected multiple tr of 2 samples per symbol (sps) for timing recovery. The sequential digital values DV are written into the FIFO 52 at a free running rate of about 5/4 samples per symbol (sps). An overflow from the accumulator 68 causes the interpolators 58 and 60 to read digital values DV[n] from the FIFO 52 in the same order that they were written (first in first out).

The interpolators 58 and 60 store the digital values DV so that they can perform interpolations between a new reading from the FIFO 52 and a last previous reading when the accumulator 68 overflows or between last and second to last previous reading when the accumulator 68 does not overflow. Both interpolators 58 and 60 interpolate with the same interpolation fraction mu. The successive interpolations with the successive interpolation fractions mu are identified with successive index numbers si# for cycles of the interpolation clock signal INPclk.

The example shows digital values DV[1−L] to DV[11−L] written to the FIFO 52 at cycles of the ADCclk where L is a length of the FIFO 52. The digital values DV1 to DV11 are read L later by the interpolators 58 and 60 when the accumulator 68 overflows.

The following description of the numerical example applies equally to the operation of each of the interpolators 58 and 60. At INPclk index si₀, the accumulator 68 overflows, a new digital value DV1 is read and stored, and the interpolator interpolates the digital value DV1 with a digital value DV0 (stored in the interpolator from a prior reading) to calculate a moving interpolation value MI0=(0/8)DV1+(8/8)DV0. At INPclk index si₁, the interpolator interpolates the most recent digital value DV1 with the second most recent digital value DV0 to calculate a moving interpolation value MI1=(5/8)DV1+(3/8)DV0. At INPclk index si₂, a new digital value DV2 is read with an accumulator overflow and the interpolator interpolates the new digital value DV2 with the most recent prior digital value DV1 to calculate a moving interpolation value MI2=(2/8)DV2+(6/8)DV1. At INPclk index si₃, the interpolator interpolates the most recent digital value DV2 with the second most recent digital value DV1 to calculate a moving interpolation value MI3=(7/8)DV2+(1/8)DV1.

At INPclk index si₄, a new digital value DV3 is read with an accumulator overflow and the interpolator interpolates the new digital value DV3 with the most recent prior digital value DV2 to calculate a moving interpolation value MI4=(4/8)DV3+(4/8)DV2. At INPclk index si₅, a new digital value DV4 is read with an accumulator overflow and the interpolator interpolates the new digital value DV4 with the most recent prior digital value DV3 to calculate a moving interpolation value MI5=(1/8)DV4+(7/8)DV2. At INPclk index si_{b}, the interpolator interpolates the most recent digital value DV4 with the second most recent digital value DV4 to calculate a moving interpolation value MI6=(6/8)DV4+(2/8)DV3.

At INPclk index si₇, a new digital value DV5 is read with an accumulator overflow and the interpolator interpolates the new digital value DV5 with the most recent prior digital value DV4 to calculate a moving interpolation value MI7=(3/8)DV5+(5/8)DV4. At INPclk index si_{g}, a new digital value DV6 is read with an accumulator overflow and the interpolator interpolates the new digital value DV6 with the most recent prior digital value DV5 to calculate a moving interpolation value MI8=(0/8)DV6+(8/8)DV5. The determinations of moving interpolations MI8 to MI15 repeat the pattern described above for the determinations of the moving interpolations MI0 to MI7.

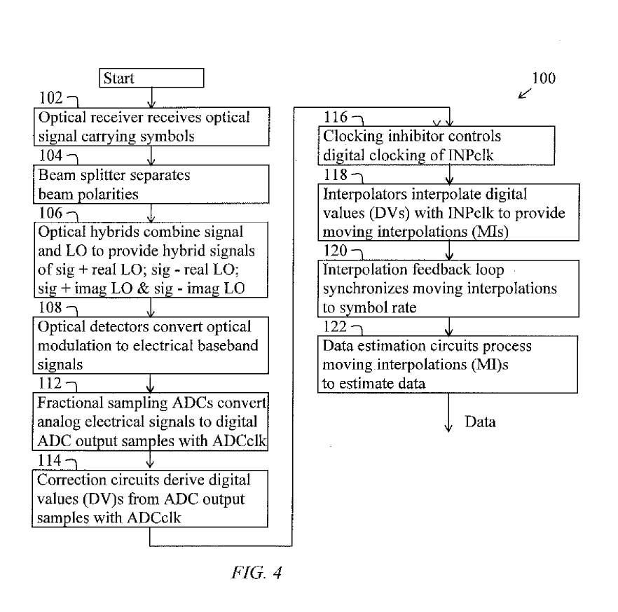

FIG. 4 is a flow chart of steps of an example of a method for receiving a modulated optical signal and processing the signal with fractional sampling and interpolation timing recovery. Any one or more of the steps in this method may be stored on a tangible medium 100 in a computer-readable form as instructions that may be read by a computer for instructing an optical receiver for carrying out the steps. The tangible medium 100 may be one or more physical articles. Examples of such physical articles are magnetic discs known as hard discs and optical discs known as DVDs or DVRs.

An optical receiver, in a step 102, receives an incoming modulated optical signal carrying symbols from a transmitter through an optical channel. The symbols represent encoded data. In a step 104 a beam splitter separates horizontal and vertical polarization states of the optical signal. In a step 106, optical hybrids in horizontal and vertical signal paths combine the incoming horizontal and vertical signals with an optical local oscillator signal to provide hybrid output optical signals. The hybrid output optical signals are beating signals for incoming signal+real local oscillator signal, incoming signal−real local oscillator signal, incoming signal+imaginary local oscillator signal, and incoming signal−imaginary local oscillator signal for each of the horizontal and vertical polarization states.

Optical detectors, in a step 108, follow the modulation on the hybrid output optical signals to provide baseband electrical signals proportional to the modulation. In a step 112, fractional analog-to-digital converters sample the electrical signals with the ADCclk signal to provide digital values as ADC output samples. In a step 114 the ADC output samples are processed in AIR circuitry to make IQ corrections for analog impairments that occur in the optical transmitter, optical channel and/or front end of the optical receiver. The corrected ADC output samples are generated as digital values DV's to interpolation timing recovery (synchronization) circuitry. In a step 116 the digital clocking of the interpolation timing recovery circuits is controlled to stop or freeze the circuits or swallow clock pulses to synchronize to the symbol rate. For the step 116, the interpolation clock signal INPclk may be gated with the FIFO valid flag F.

The interpolators, in a step 118, interpolate the digital values DV's to provide values for moving interpolations MI's. In a step 120 an interpolation feedback loop synchronizes the moving interpolation values MI's to a selected multiple tr of the incoming signal symbols. In a step 122 the data is estimated from the symbols that are carried by the values of the moving interpolations.

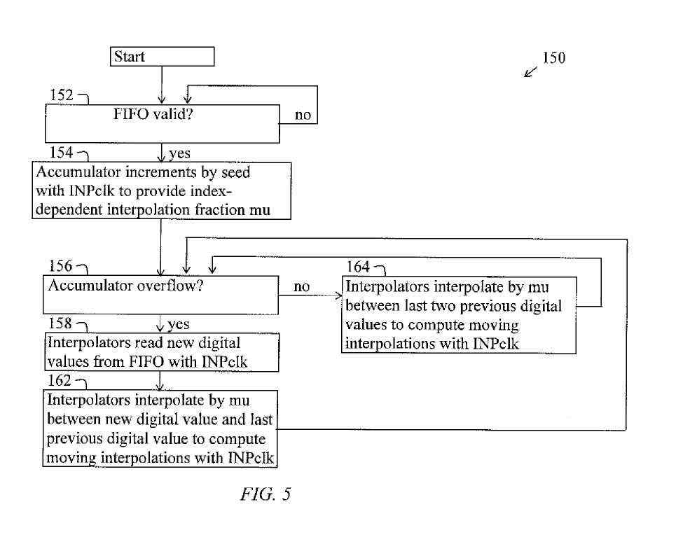

FIG. 5 is a flow chart of an example of a method for timing recovery with interpolation. Any one or more of the steps in this method may be stored on a tangible medium 150 in a computer-readable form as instructions that may be read by a computer for instructing an optical receiver for carrying out the steps. The tangible medium 150 may be one or more physical articles. Examples of such physical articles are magnetic and optical discs.

The FIFO flag F in a step 152 is set to valid when the FIFO 52 is full and not valid when the FIFO 52 is empty. When the FIFO flag F indicates the FIFO 52 is empty the clock operation of the interpolation clock signal INPclk is inhibited. In a step 154 when the FIFO flag F indicates the FIFO 52 is full the accumulator 68 increments with the interpolation clock signal INPclk by a seed to provide the index-dependent interpolation fraction mu.

In a step 156 when the addition (accumulation) of the seed to the output of the accumulator 68 causes the accumulator output to exceed its modulus, the accumulator 68 overflows. In a step 158 when the accumulator 68 overflows, the interpolators 58 and 60 read the new digital values DV_{X} and DV_{T} from the FIFO 52. In a step 162 using the interpolation clock signal INPclk, the X interpolator 58 interpolates by mu between the new digital value DV_{X}[n] and the stored most recent previous digital value DV_{X}[n−1] to compute the new moving interpolation value MI_{X}. Similarly, using the interpolation clock signal INPclk, the Y interpolator 60 interpolates by mu between the newly read digital value DV_{T}[n] and the stored most recent previous digital value DV_{X}[n−1] to compute the new moving interpolation value MI_{T}.

When the accumulator 68 does not overflow in the step 156, then in a step 164 using the interpolation clock signal INPclk, the X interpolator 58 interpolates by mu between the stored last previous digital value DV_{X}[n] and the stored second to last previous digital value DV_{X}[n−1] to compute the new moving interpolation value MI_{X}. Similarly, using the interpolation clock signal INPclk, the Y interpolator 60 interpolates by mu between the last previous digital value DV_{T}[n] and the second to last previous digital value DV_{X}[n−1] to compute the new moving interpolation value MI_{T}.

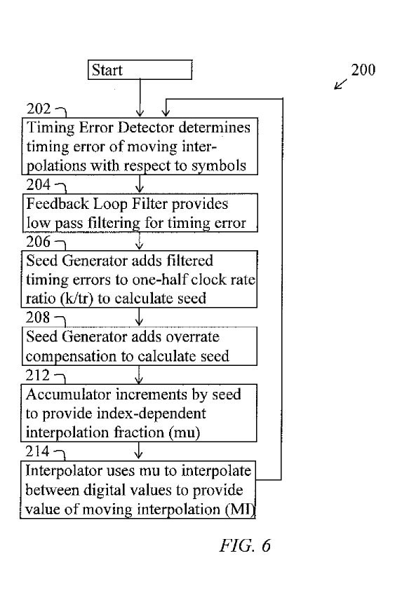

FIG. 6 is a flow chart of steps for an example of a method for using feedback in an interpolation loop for interpolation timing recovery. Any one or more of the steps in this method may be stored on a tangible medium 200 in a computer-readable form as instructions that may be read by a computer for instructing an optical receiver for carrying out the steps. The tangible medium 200 may be one or more physical articles. Examples of such physical articles are magnetic and optical discs.

The steps in the feedback are operated with the interpolation clock signal INPclk with the gating condition that the FIFO flag F shows that the FIFO 52 is valid. When the FIFO 52 is not valid the steps are stopped until the FIFO 52 is again valid by writing new digital values derived from the ADC output samples with the ADCclk signal. In a step 202 the timing error detector 62 determines timing errors between the sequence of moving interpolations MI_{X} from the X interpolator 58 and the symbols that are carried by the sequence of moving interpolations MI_{X}. In a step 204 the timing errors are filtered by a low pass filter 64. In a step 206 the seed generator 66 adds the filtered timing error to the clock rate ratio k/tr scaled by the accumulator modulus. Where the data estimator 34 operates at 2 sps, the clock rate ratio is k/2. In a step 208 optionally the seed generator 66 adds an overrate compensation Δ to provide an open loop correction to the rate at which the X and Y interpolators 58 and 60 read from the FIFO 52. This correction may be desired to reduce the frequency with which the FIFO 52 becomes not valid.

The accumulator 68 in a step 212 increments by the seed to provide the index-dependent interpolation fraction mu at the accumulator output. Then, in a step 214 the X and Y interpolators 58 and 60 use the fraction mu to interpolate between consecutive digital values DV_{X} and DV_{T}, respectively, to provide moving interpolations MI_{X} and MI_{T}, respectively.

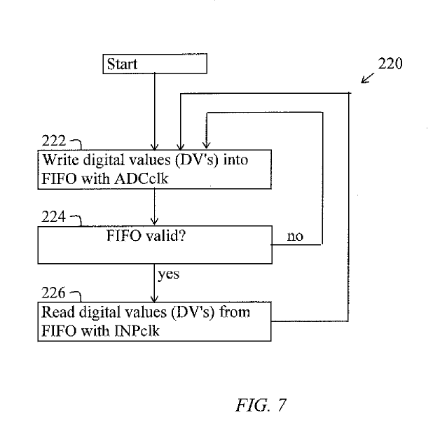

FIG. 7 is a flow chart of steps of an example of a method for synchronizing the digital clocking of the optical receiver 10 to the incoming signal symbols. Any one or more of the steps in this method may be stored on a tangible medium 220 in a computer-readable form as instructions that may be read by a computer for instructing an optical receiver for carrying out the steps. The tangible medium 220 may be one or more physical articles. Examples of such physical articles are magnetic and optical discs.

Complex digital values DV_{X} and DV_{Y} in a step 222 are written into the FIFO 52 with cycles of the free running ADCclk signal. In a step 224 when the FIFO 52 is not empty, the clocking inhibitor 54 generates the FIFO flag F to indicate that the FIFO 52 is valid. In a step 226 when the FIFO 52 is valid, the digital values DV_{X} and DV_{Y} are read by the X and Y interpolators 58 and 60, respectively, at accumulator overflows with cycles of the interpolation clock signal INPclk. When the FIFO 52 is not valid, the X and Y interpolators 58 and 60 are inhibited or prevented from using the interpolation clock signal INPclk until new digital values DV_{X} and DV_{Y} are written into the FIFO 52 and the FIFO 52 becomes valid. The operation of the clocking inhibitor 54 can be viewed as swallowing cycles of the interpolation clock signal INPclk with the effect that the interpolation clock signal INPclk becomes synchronized in the data domain with the symbols. It should be noted that in the time domain there would be time gaps in the operation of the digital circuits having clocking that is controlled by the FIFO flag F.

FIG. 8 is a block diagram of an example of the interpolation synchronizer 250 for the optical receiver 10. The interpolation synchronizer 250 includes the FIFO 52, the clocking inhibitor 54, the X interpolator 58 and the Y interpolator 60 as described above, and an interpolation feedback loop 256 where the interpolation feedback loop 256 has two stages of interpolation. The first stage of interpolation is the interpolator 58 and the second stage of interpolation is a second interpolator 258 referred to as a timing error detector (TED) interpolator 258.

The first stage of interpolation 58 in the interpolation feedback loop 256 provides the moving interpolations MI_{X}, as described above, to the data estimator 34 at the selected symbol rate multiple tr sps. The second stage interpolator 258 (TED interpolator 258) interpolates the moving interpolations MI_{X} to provide second interpolations MIₓ₂ to the timing error detector 62.

The interpolation feedback loop 256 includes the X interpolator 58, the timing error detector 62, the loop filter 64, the seed generator 66 and the accumulator 68 as described above, and a timing error detector (TED) translator 270. The TED translator 270 includes a TED FIFO 274, a TED accumulator 278, and the TED interpolator 258. The interpolation clock 36 in the optical receiver 10 is replaced by the combination of a 2SCLK clock 36A and a TED divider 36B.

The 2SCLK clock 36A generates a clock signal 2sclk at a free running rate of nominally 2 sps or slightly greater than 2 sps. The TED divider 36B frequency divides the 2sclk by 2/tr. The effect of the frequency division is to multiply the frequency of the 2sclk signal by tr/2 to provide the interpolation clock signal INPclk at tr sps. The 2sclk signal (controlled as described above by the flag F) is used by the translator 270, the timing error detector 62 and the loop filter 64. The INPclk signal (controlled as described above by the flag F) is used by the X and Y interpolators 58 and 60, the seed generator 66 and the accumulator 68, and is passed to the data estimator 34.

The moving interpolations MI_{X} are synchronized to the incoming signal samples by the interpolation feedback loop 256 at a rate of tr samples per second (sps) where tr is the selected multiple of the symbol rate. The moving interpolations MI_{Y} are provided at the same tr sps rate by the Y interpolator 60. The two stage interpolation is especially advantageous to use timing error detector techniques and algorithms that are available for synchronization at two times the symbol rate while simultaneously providing moving interpolations MI's for data estimation at rates other than two times the symbol rate (tr not equal to 2).

The FIFO 274 receives the moving interpolations MI_{X} at the rate of tr sps. The interpolator 258 and the accumulator 278 are clocked with the 2sclk signal controlled by the flag F from the FIFO 52. The interpolator 258 reads the moving interpolations MI_{X} at the rate of a second stage overflow (overflowₙ) from the accumulator 278 and interpolates between the moving interpolations MI_{X} to provide the second interpolations MIₓ₂. The TED accumulator 278 operates with a second stage modulus (modulus₂) and a second stage seed (seed₂) to generate second stage index-dependent interpolation frequency mu's (mug's) and generate the overflow₂'s when the modulus₂ is exceeded by the accumulation in a similar manner to the above described accumulator 68. In some implementations, the seed₂ is the clock rate fraction tr/2 times the modulus₂. The flag F stops the operation of the FIFO 274, interpolator 258 and accumulator 278 when the FIFO 52 is invalid.

The interpolation synchronizer 250 with the two stage interpolation has the benefit of enabling the timing error detector 62 to operate with clocking at 2 sps while the data estimator 34 operates with a possibly different clocking rate of tr sps. This also enables the ADC's 30 to operate at a free running rate that is independent of the incoming symbol rate and independent of the selected tr rate so that the optical receiver 10 can be used in optical systems with different symbol rates. The TED interpolator 258 interpolates between the moving interpolations MI_{X} synchronized to tr sps (in the data domain) to provide to the moving interpolations MIₓ₂ synchronized to 2 sps (in the data domain).

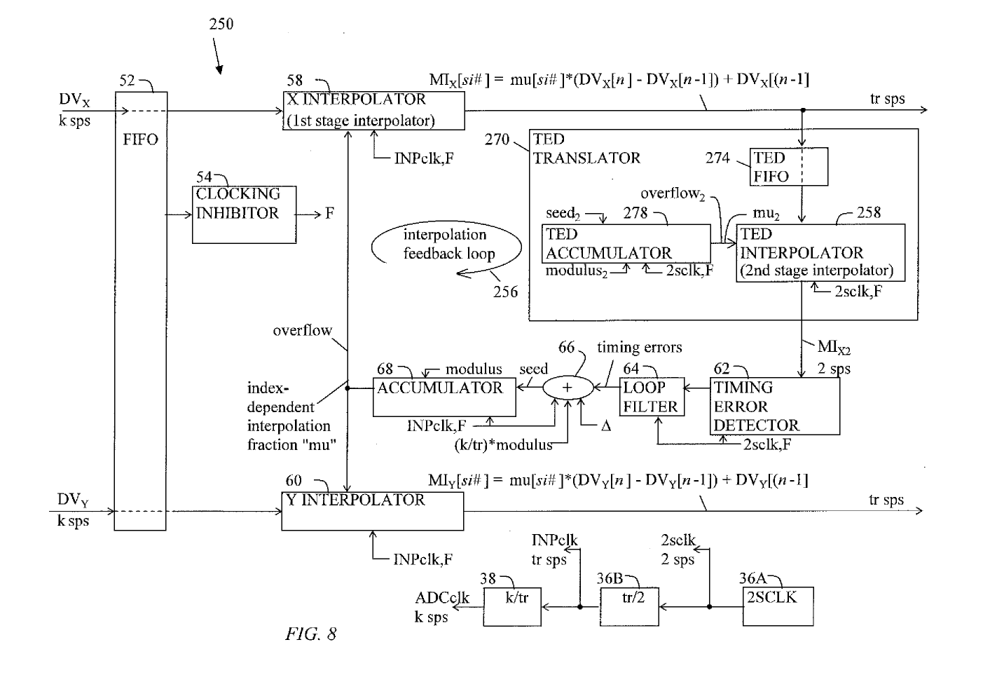

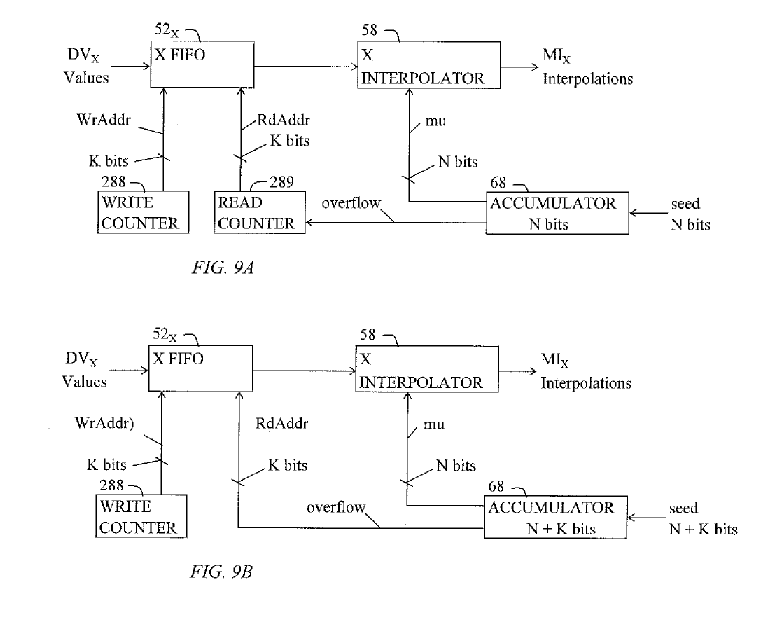

FIGS. 9A and 9B are block diagrams showing an example of the operation of the FIFO 52 for the interpolation synchronizer circuits 50 and 250. The X part of the FIFO 52 is referred to as FIFO 52_{X}. The X FIFO 52_{X} is 2̂K in length. The digital values DV_{X} are written into the X FIFO 52_{X} at addresses provided by a write counter 288 with an address word (WrAddr) length of K bits. The digital values DV_{X} are read by the X interpolator 58 at overflows of the accumulator 68 at read address words (RdAddr) provided by a read counter 289 or as a part of an overflow word from the accumulator 68. The interpolation fraction mu generated by the accumulator 68 has length of N bits. In FIG. 9A, where the read counter 289 is used to generate the read address the accumulator 68 and the seed word have lengths of N bits. In FIG. 9B, where the overflow word is used to generate the read address the accumulator 68 and the seed word have N+K bits.

The reader may refer to the numerical example FIG. 3 and the flow charts of FIGS. 4-7 and accompanying written descriptions for additional details for the block diagrams of the FIGS. 1, 2, 8, and 9A-B; and conversely refer to the block diagrams of the FIGS. 1, 2, 8 and 9A-B, and numerical example FIG. 3 and accompanying written descriptions for additional details for the flow charts of FIGS. 4-7.

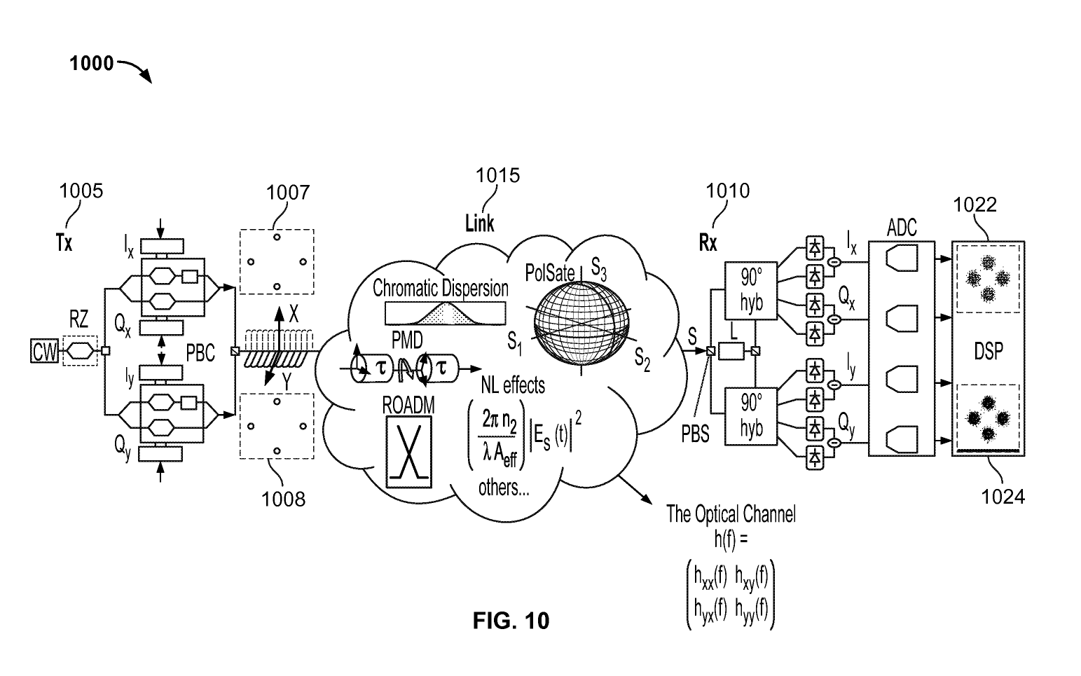

FIG. 10 shows a block diagram of an example communications system 1000 including a transmitter system 1005 in communication with a receiver system 1010 via a communications link 1015. For example, the receiver system 1010 can be implemented as the receiver system 10 described above in connection with FIG. 1. The transmission signal can be multiplexed based on a PM-QPSK scheme. The signal tributaries are represented by diagrams 1007 and 1008 and correspond to respective orthogonal polarizations of the signal, S, transmitted by the transmitter signal 1005. The transfer function of the optical link 1015, h(f), takes into account degradation in the transmitted signal due to polarization mode dispersion (PMD), chromatic dispersion (CD), non-linear effects, and the like. The foregoing degradations can occur in the transmission medium, e.g., various types of optical fiber, or in link components, e.g., reconfigurable optical add-drop multiplexers (ROADM) and the like. The signal S received at the receiver system 1010 can be processed as described in connection with FIGS. 1-8 and 9A-9B to recover the tributary signals 1022 and 1024 corresponding to the orthogonal polarizations of the received signal S.

At data rates of order 100G, the PM-QPSK communications system 1000 with 20% FEC can lower a baud rate by a factor of 4 with respect to communication systems having no FEC, can improve the OSNR tolerance in comparison to DD, and can compensate linear impairments through digital signal processing, e.g., as described above in connection with FIGS. 1-8 and 9A-9B. However, implementing the 100G PM-QPSK communications system 1000 with 20% FEC can present multiple challenges. For example, performance of the analog-to-digital converters (ADC) must improve to meet and exceed the required high speed and quality, e.g. the effective number of bits (ENOB) of the digitized signals in the 100G PM-QPSK communications system 1000. In addition, the gate count necessary for performing such digital signal processing must be balanced to achieve the required performance and functionality of the communications system 1000. Further advancements in photonics, and specifically in integrating optical components with electronics, also are required for implementing a 100G PM-QPSK communications system as shown in FIG. 10. Such integration must solve thermal management issues due to, e.g., leakage current in various fabrication geometries—90, 65, 40 nm—of the integrated circuits included in components of the 100G PM-QPSK communications system 1000.

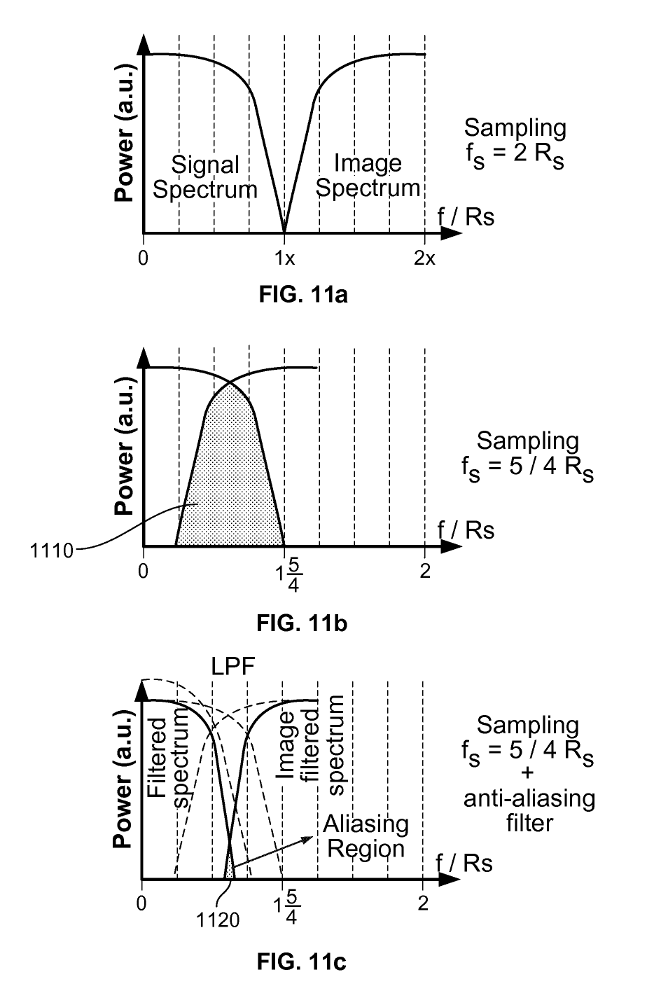

FIG. 11 shows a qualitative representation of aliasing effects with and without using anti-aliasing filters. In accordance with the Nyquist-Shannon sampling theorem, if a function f(t) contains no frequencies higher than W cycles per second (cps), the function f(t) is completely determined by giving its ordinates at a series of points spaced ½ W seconds apart. Panels (a), (b) and (c) of FIG. 11, represent the symbol rate (or data rate) Rs of the transmitted/received signal. Sampling performed at a sampling frequency, fs, which is close to the symbol rate Rs, can be sensitive to aliasing 1110, as depicted by the grey-shaded region in panel (b) of FIG. 11, for a sampling frequency fs= 5/4Rs (or η=1.25, where η is the relative sampling rate with respect to the symbol rate.) To reduce a size of the aliasing region 1110, one can increase the sampling rate fs to or above twice the highest signal frequency as illustrated in panel (a) of FIG. 11. Another way to reduce the size of the aliasing region 1110 is to introduce anti-aliasing filters as illustrated in panel (c) of FIG. 11. The aliasing region 1120 in this case can be controlled by optimizing the properties/characteristics of the anti-aliasing filters as described below in this specification. In some implementations, the antialiasing filters can be low-pass filters.

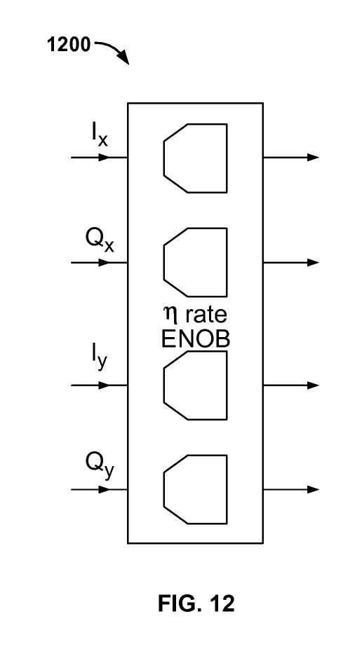

FIG. 12 shows a block diagram of an example of an analog-to-digital converter (ADC) 1200. The ADC 1200 is configured to receive analog signals Ix, Qx, Iy and Qy and to output corresponding digital signals for further processing. In addition, the ADC 1200 can be characterized by an effective sampling rated η (in terms of the symbol rate Rs), and by an effective number of bits (ENOB). A figure of merit (FOM) can be defined for the ADC 1200 as,

FOM=P_{ADC}/(2^{ENOB}*η*Rs) (3),

where P_{ADC} is the power dissipated at the ADC 1200. The FOM given by EQ. 3 represents the energy (in J) per conversation-step. If the ADC sampling rate, η, increases and the FOM is maintained substantially constant, then the ADC power dissipation P_{ADC} is expected to increase (in the frequency range between f and f²) There are multiple reasons for lowering the sampling frequency. For communications based on PM-QPSK at 127 Gb/s (corresponding to a symbol rate Rs=31.625 GSym/s), the ADC 1200 should have a sampling frequency fs≧2 Rs=64 GSa/s in order to satisfy the Nyquist-Shannon theorem. However, existing ADC devices based on CMOS/SiGe technology rarely achieve sampling rates fs>20 GSa/s. For improved performance, the ADC 1200 also should exhibit reduced implementation complexity and should have low power consumption/dissipation, e.g., the ADC 1200 should have a low modem gate count. Such improvements can be achieved by placing a CD filter at an optimal location with respect to the ADC 1200 to obtain increased tolerance to CD.

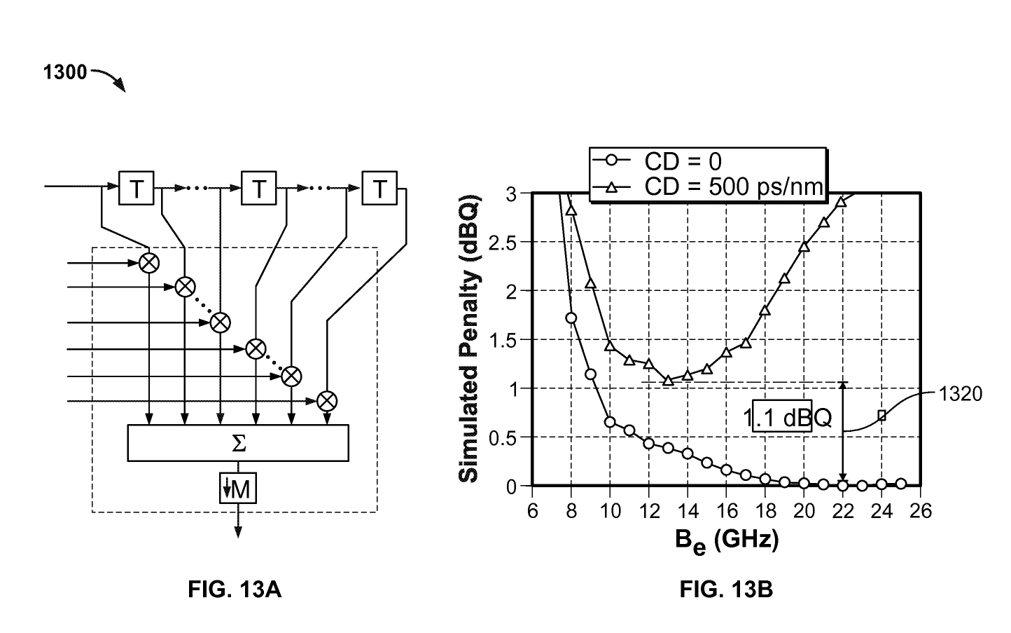

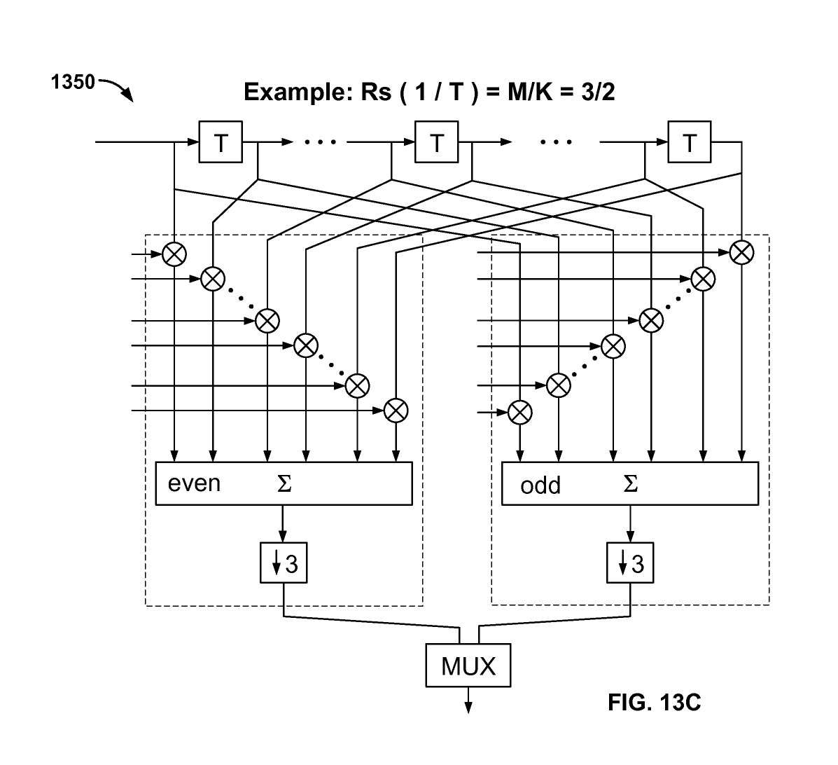

FIG. 13A shows a block diagram of an example of a symbol rate equalizer 1300 that can be used to perform sampling at the symbol rate Rs. The tap length T of the symbol rate equalizer 1300 is related to the symbol rate Rs via the relation Rs(1/T)=1 (or in general Rs(1/T)=M, where M is an integer.) However, the symbol rate equalizer 1300 must be operated in conjunction with an external error signal to find the best sampling phase. In addition, the symbol rate equalizer 1300 can be sensitive to aliasing. As shown in FIG. 13B, an optical signal-to-noise ratio (OSNR) penalty 1320 of 1.1 dB may occur for a CD=+500 ps/nm during operation of the symbol rate equalizer 1300. Other measurements have shown that the OSNR penalty can be 1.5 dB for CD=−500 ps/nm.

FIG. 13C shows a block diagram of an example of a fractionally spaced equalizer 1350. The tap length T of the fractionally spaced equalizer 1350 is related to the symbol rate Rs via the relation Rs(1/T)=M/K, where M, K are integers, M>K and M/K is a rational fraction. In contrast with the symbol rate equalizer 1300, the rational over-sampling equalizer 1350 does not require a closed time sampling loop to find the best sampling fs, but does require multiple (K>1) different filter “banks”

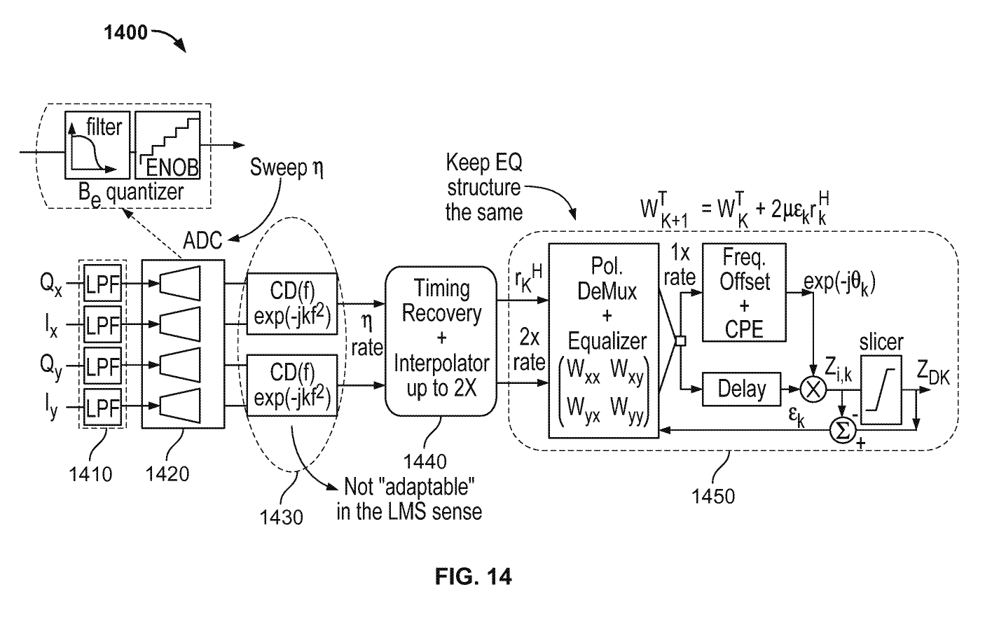

FIG. 14 shows a block diagram of an example of a receiver system 1400. For example, the receiver system 1400 can be implemented as the receiver system 1010 in the PM-QPSK communications system 1000. The symbol rate provided by the transmitter system 1005 can be Rs. The receiver system 1400 depicted in FIG. 14 can be configured for subsampling received signals that have a symbol rate Rs of order 100G.

The receiver system 1400 includes an ADC 1420. The sampling rate fs of the ADC 1420 can be expressed relative to the Rs as fs=η*Rs. The sampling rate η of the ADC 1420 can be varied from 1 to 2, for instance. The ADC 1420 can include corresponding electrical low-pass filters (having an effective 3 dB bandwidth Be) and corresponding quantizers (having a specified ENOB) for each of the inputs Qx, Ix, Qy and Iy of the ADC 1420. In addition, respective optical low-pass filters from a set of optical low-pass filters 1410 can be coupled upstream from the inputs Qx, Ix, Qy and Iy of the ADC 1420. Each of the optical low-pass filters of the set of optical low-pass filters 1410 has an effective 3 dB bandwidth Bo. The characteristics Be and Bo of the electrical and optical filters associated with the ADC 1420 can be optimized to mitigate aliasing effects due to operating the ADC at a sampling rate η between 1 to 2.

The receiver system 1400 further can include frequency domain CD filters 1430 that can be coupled downstream from the ADC 1420 to remove any bulk CD that is sample rate independent. For example, the frequency domain CD filters can be implemented as the AIR circuitry 32 described above in connection with FIG. 1. The outputs of the frequency domain CD filters 1430 are operated at a rate η. Moreover, the frequency domain CD filters 1430 are not adaptable in the LMS sense.

The receiver 1400 also includes a timing recovery+interpolator module 1440 to resample the data at 2×. The module 1440 can be coupled downstream from the CD filters 1430 and can include a digital interpolator, a timing error detector, a low pass filter and a numerically controlled oscillator. An example of a timing+recovery module 1440 can be implemented as the timing recovery interpolation synchronizer 50, 250 described in detail above in connection with FIGS. 1, 2 and 8. The timing recovery+interpolator module 1440 operated to resample up to 2 Rs can be employed in order to use the same rate equalizer for different sampling rates η of the ADC 1420. The fact that such interpolation does not degrade the signal quality has been confirmed experimentally by configuring a corresponding rational M/K equalizer (as described in FIG. 13C) and comparing the performance of the two configurations (with and without resampling to 2×). The outputs r_{i,k} of the timing recovery+interpolator module 1440 are at a rate 2×, where the subscript i represents the x or y polarization, and the subscript k represents a symbol or block index.

Further, the receiver 1400 contains a set of modules 1450 coupled downstream from the timing recovery+interpolator module 1440. The set of modules 1450 includes an adaptive time domain equalizer (e.g., having 33 taps), a frequency correction block, a carrier phase estimation block (e.g., having a 41 symbols averaging window) and a slicer. The outputs of the adaptive time domain equalizer are operated at a rate 1×. The constellation estimation Z_{i,k} also is operated at a rate 1×. Further, εₖ=Z_{Dk}−Z_{i,k} represents the LMS error, and Z_{Dk} represents the sliced constellation.

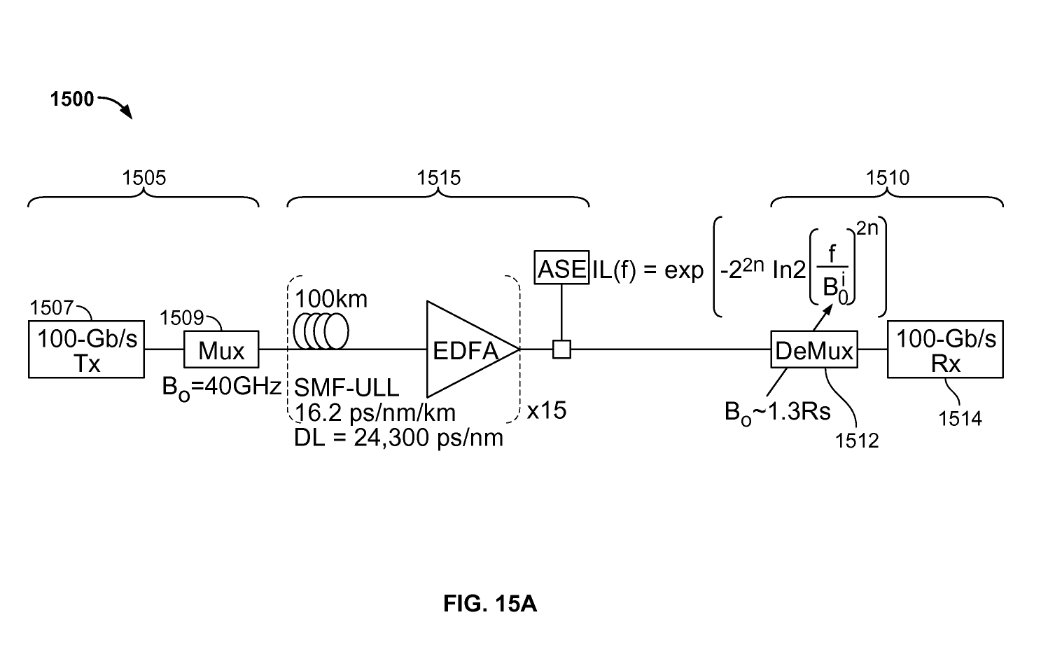

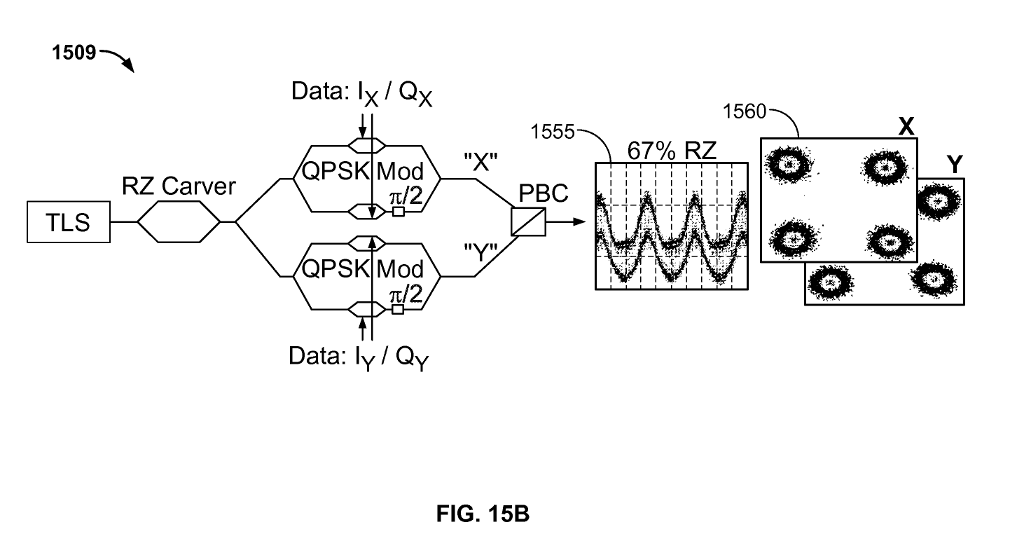

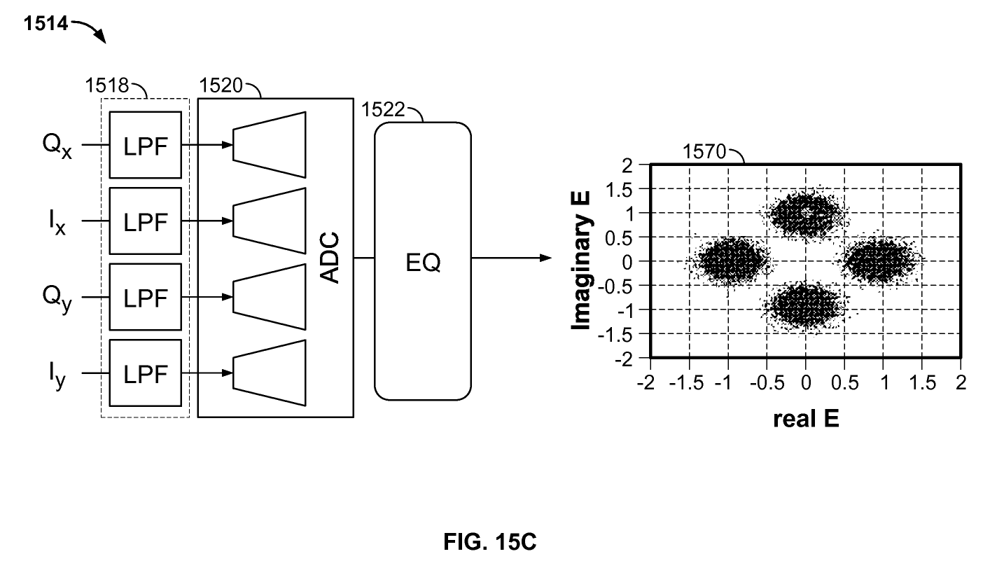

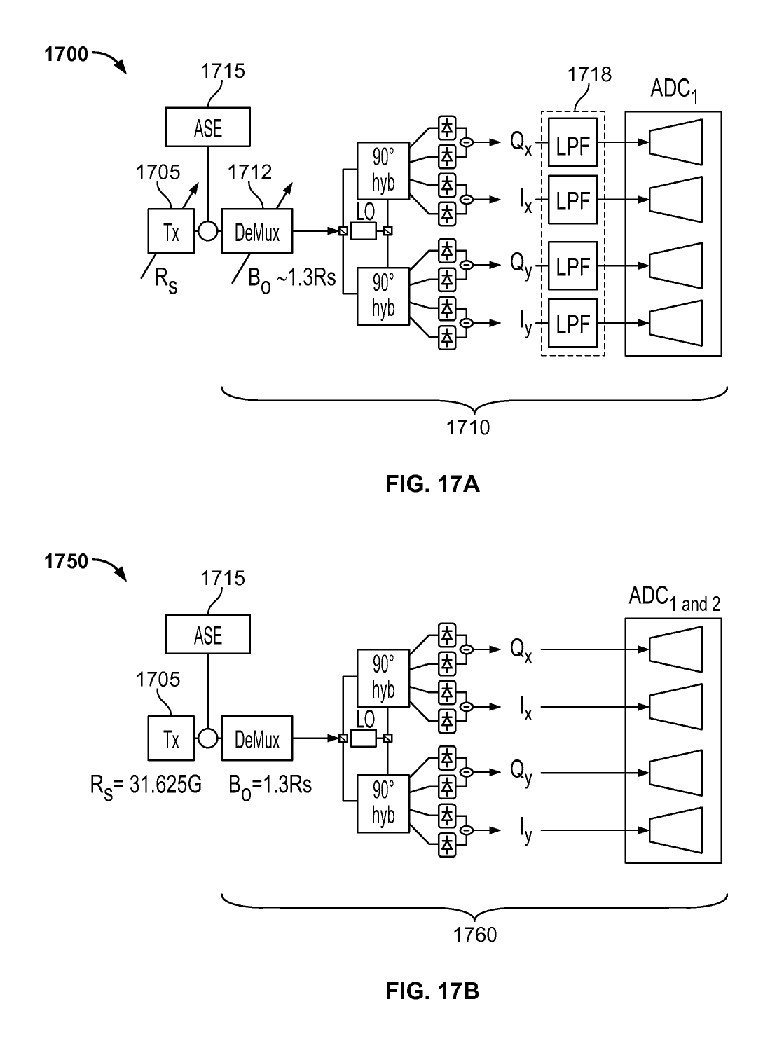

FIGS. 15A-15C show aspects of a communications system 1600 including a transmitter system 1505 and a receiver system 1510 coupled via a communications link 1515. The communications system 1500 can be used to measure the performance of the receiver system 1510 when the latter is implemented in accordance with the configuration described above in connection with FIG. 14. In some implementations, the effective sampling rate η can be varied by changing the symbol rate Rs at the transmitter system 1505 while keeping the ADC sampling rate fs fixed at the receiver system 1510. Such an implementation of the communications system 1500 is described in detail below in connection with FIG. 17A. In other implementations, the effective sampling rate η can be varied by changing the ADC sampling rate fs at the receiver system 1510 while keeping the symbol rate Rs fixed at the transmitter system 1505. Such other implementation of the communications system 1500 is described in detail below in connection with FIG. 17B.

The communications link 1515 can include 15 spans of 100 km of Corning SMF-28 ultra-low loss (ULL) fiber (16.2 ps/nm/km at 1550 nm) and can cause a chromatic dispersion CD of 24,300 ps/nm. In addition, the communications link 1515 can exhibit a background noise mechanism common to all types of erbium-doped fiber amplifiers (EDFAs) called amplified spontaneous emission (ESA) noise. The ESA noise can contribute to the noise figure of the link and causes degradation of the signal-to-noise ratio (SNR).

The transmitter system 1505 can include a 100-Gb/s transmitter 1507 followed by an optical multiplexer 1509. In some implementations, the 3 dB bandwidth of the optical multiplexer 1509 can be Bo=40 GHz. FIG. 15B shows a block diagram of an example of the optical multiplexer 1509. In this example, the optical multiplexer 1509 includes a coherent, tunable laser source (TLS), an RZ carver, and corresponding data modulators for providing QPSK modulation to Ix and Qx tributaries corresponding to polarization x, and to Iy and Qy tributaries corresponding to polarization y. The RZ carver is biased and driven to produce 67% duty cycle RZ pulses 1555. The four PM-QPSK tributaries 1560 are output by the transmitter system 1505 for transmission to the receiver system 1510. The output of the transmission system 1505 corresponds to an effective optical filter having a bandwidth of 40 GHz (FWHM).

The receiver system 1510 can include a 100-Gb/s receiver 1514 preceded by an optical de-multiplexer 1512. In some implementations, the optical de-multiplexer 1514 corresponds to an effective, tunable optical filter that can be adjusted to have a 3 dB bandwidth Bo˜1.3 Rs, in terms of the symbol rate. FIG. 15C shows a block diagram of the 100-Gb/s receiver 1514 including an ADC 1520 and a module 1522 including an equalizer component. For example, the 100-Gb/s receiver 1514 can be implemented as the receiver system 1400 described above in connection with FIG. 14. The ADC 1520 can be arranged with an effective electrical low-pass filter having a 3 dB bandwidth Be. In some implementations, additional electrical filters 1518 can be connected before the ADC 1520. The 100-Gb/s receiver 1514 can be configured to process the received four PM-QPSK tributaries 1570, for example, by using a sampling rate η between 1 and 2.

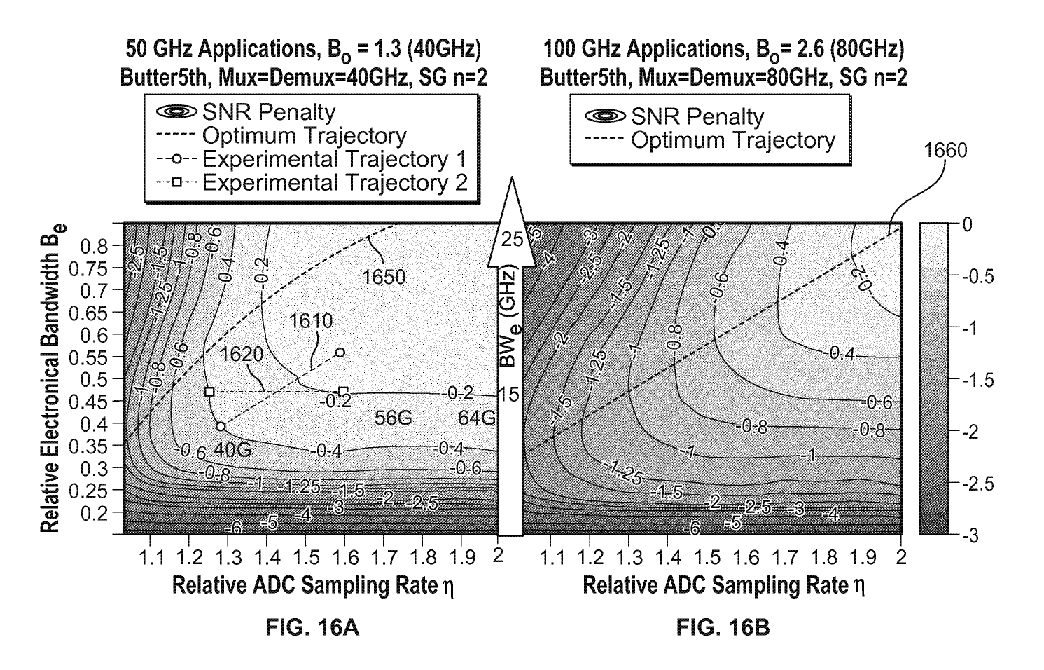

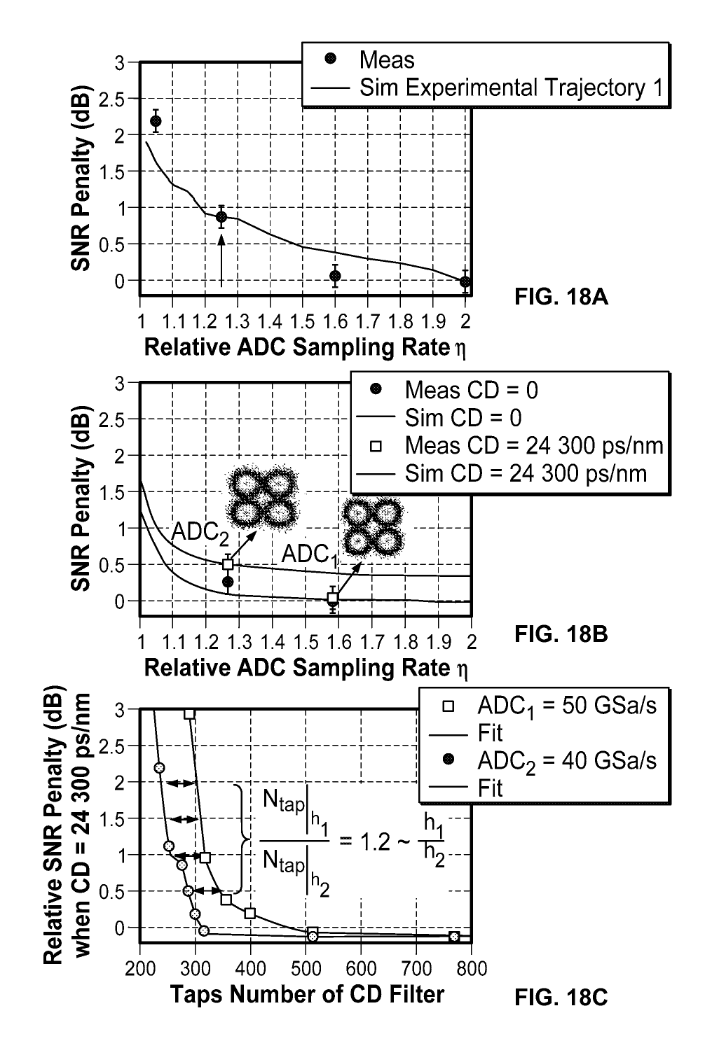

The metric used to characterize the performance of the receiver system 1510 is the signal to noise ratio (SNR) where SNR=Signal Power/Noise Power=<|Zₖ|²>/<|Z_{Dk}−Zₖ|²>, where Zₖ is the input symbol to the slicer and Z_{Dk} is the slicer output, in accordance with the nomenclature disclosed in connection with FIG. 14. In non-differential mode, if there is no cycle-slip (confirmed experimentally), the relationship between the SNR and the bit-error-rate (BER) for QPSK communications is given by BER=½*erfc*√(½SNR), where erfc is the complementary error function (SNR and Q factor are equivalent). The SNR penalty has been calculated at a reference SNR=10 dB (BER=8e−4). In simulation and in offline processing, ˜2¹⁸ symbols for each of the four PM-QPSK tributaries 1570 have been processed. The average SNR values calculated from the x and y channels are reported below in connection with FIGS. 16 and 18.

At a sampling rate lower than 2×, careful attention should be paid in the choice of the analog filters to avoid aliasing. In principle, optical or electrical filters have the same effect on the SNR performance, since a coherent receiver (e.g., the receiver system 1510) can detect the beating of the electric fields of the signal and an oscillator local to the receiver system 1510. In reality, the optical filters roll off more sharply with frequency than electrical filters (optical filters typically roll off with a Super-Gaussian (SG) with order 2 to 4 in contrast to Butterworth or Bessel-Thompson responses for electrical filters).

FIG. 16 shows the SNR penalty (in negative values) versus the ADC rate and the analog bandwidth Be (single sided normalized by Rs) of the electrical filter for a 5^{th} order Butterworth and for two optical filter bandwidths Bo (double sided normalized by Rs and with SG-2nd order; Rs corresponds to the symbol rate at the mux/de-mux). In panel A of FIG. 16, the bandwidth is Bo=1.3 (corresponding to a 40 GHz bandwidth) and corresponds to 50 GHz spacing applications at 31.6 GSymbol/s. In panel B of FIG. 16, the bandwidth is Bo=2.6 (corresponding to a 80 GHz bandwidth) and corresponds to 100 GHz spacing applications at 31.6 GSymbol/s.

The best performance is obtained at η=2 with Be˜0.8, which is expected since 2× sampling rate prevents aliasing. For Bo=2.6, the SNR rapidly degrades, when η is reduced below 2 and when Be is high, due to strong aliasing. Lowering Be removes some of the aliasing effect (as illustrated by the curve 1660 labeled “optimum trajectory” which shows the lowest SNR penalty versus η and Be). For Bo=1.3, the performance variation with reduced sampling rate is much lower because the optical filter removes the majority of the aliasing without causing large signal distortion. The ADC sampling rate η can be reduced to 1.25 with less than 0.5 dB penalty for Be ranging from 0.4 to 0.6.

Two types of SiGe ADCs with similar analog bandwidths (15±1 GHz close to a Butterworth) and ENOB characteristics (from 5 to 4, varying with frequency) were tested. The first type of tested ADC can run at 50 and 25 GSa/s and the second type of tested ADC can run at 40 GSa/s. Two types of experiments have been performed.

FIG. 17A shows a block diagram of a communications system 1700 used for the first experiment. The communications system 1700 includes a transmitter system 1705 configured to operate at variable symbol rates ii. The communications system 1700 also includes a link 1715 characterized by ASE loss. Further, the communications system 1700 includes receiver system 1750 including an optical de-mux 1712 having an effective bandwidth Bo˜1.3 Rs, and an ADC1. The ADC1 has a bandwidth of 15±1 GHz (˜Butterworth). First, the ADC1 was used at fs=25 GSa/s and Rs was varied from 12.5, 15.625, 20 and 23.8095 GSymbol/s (resulting in oversampling rates of η=2, 1.6, 1.25 and 1.05). The transmitter system 1705 was calibrated and normalized with respect to Rs. Extra electrical filters 1718 (Bessel-Thompson with 10.7 GHz of bandwidth) for all η below 2 were also added in order to approach the “optimum trajectory” 1650 illustrated in panel A of FIG. 16.

The estimated overall Be versus η is illustrated in panel A of FIG. 16 as the “Experimental Trajectory 1” 1620. The Be values corresponding to the “experimental trajectory 1” 1650 are 1.2, 0.56, 0.44 and 0.37. The tunable optical de-mux 1712 was adjusted to maintain Bo=1.3 as the symbol rate Rs was varied. The tunable filter used in the experiments has a SG shape with a 2nd order above 30 GHz, but falls rapidly to an order 1 below this value. Because the added electrical filters used in the experiments followed a Bessel-Thompson shape (which is not as sharp as a Butterworth) and the optical filter shape was also getting less sharp for bandwidths below 30 GHz, the best optimum anti-aliasing combination could not be reached for lower η as part of the first experiment. This explains why in panel A of FIG. 18 the measured penalty at η=1.25 is ˜1 dB instead of 0.4 dB as predicted in panel A of FIG. 16. When the corresponding experimental parameters are used in panel A of FIG. 18 (solid curve calculated with the measured ADC1 transfer function and demux Bo), the agreement with experiment is good, confirming that the best filter combination has not been used in the first experiment.

FIG. 17B shows a block diagram of a communications system 1700 used for the second experiment. The second experiment was designed to show that the performance at lower rate η can be improved if suitable filters are used. The communications system 1700 includes the transmitter system 1705 configured to maintain a fixed symbol ratio Rs=31.6GSymbol/s. The communications system 1700 also includes a link 1715 characterized by ASE loss. Further, the communications system 1700 includes receiver system 1760. A first ADC1 at 50 GSa/s, and a second ADC2 at 40GSa/s were used, respectively, for two implementations of the receiver system 1760 (resulting in oversampling rates of η=1.58 and 1.26). The first ADC1 and the second ADC2 each has a bandwidth of 15±1 GHz (˜Butterworth). For this experimental setup, Bo=1.3 (40 GHz) with a SG-2nd order and Be˜0.5 (˜15 GHz). As shown in panel B of FIG. 18, the performance has increased substantially for lower ADC rate leading to less than 0.3 dB penalty for η≧1.25 in agreement with the simulation (solid blue curve) and very close to the experimental measurements (solid circles). In fact, the SNR penalty is less than 0.5 dB when ADC sampling rate η in the interval from 2 to 1.1 is used.

In addition, the SNR performance for communications affected by a large amount of CD was tested using the link 1715 described above. More specifically, the value of CD was 24300 ps/nm. The SNR penalty has increased slightly at η=1.25. This small increase in penalty due to CD (less than 0.2 dB) may be caused by the ENOB of the ADC used in the experiments and may not be due to aliasing. Simulations using an ENOB=5 predict an increase of penalty even at η=2 (red curve in panel B of FIG. 18). This is due to the increase in peak-to-average ratio of the signal due to CD and the limited number of bits of resolution. Accordingly, an anti-aliasing filter combination to be used for PM-QPSK receivers operated at 31.6 GSym/s can be implemented as a combination of 50 GHz optical filters and electrical BW of about 15 GHz (common for CMOS devices.)

Panel C of FIG. 18 shows CD tolerance as a function of ADC sampling rate r′ for the experimental setup described above in connection with FIG. 17B. The required quantity of taps, Nₜₐₚ, for filtering chromatic dispersion (CD) scales as the inverse of the sampling rate 1/η, in agreement with CD tolerance being proportional to the tap length. The experimental parameters used to obtain the results in panel C of FIG. 18 are CD=24300 ps/nm and Rs=31.625 GSym/s. The first ADC1 was operated at 50 GSa/s (corresponding to η=1.6) and the second ADC2 was operated at 40 GSa/s (corresponding to η=1.25). The measured relative SNR penalty for η=1.6 is represented in open squares and the measured relative SNR penalty for 11=1.25 is represented in solid circles. Moreover, the number of taps required to compensate a given CD can be 1.6 greater for standard sampling rate η=2 compared to fractional sampling rate η=1.25.

In conclusion, the interplay between the sampling rate of the ADC and the analog bandwidth of the anti-aliasing filters was determined for PM-QPSK optical receivers. Specifically, lowering the ADC sampling rate may lead to aliasing that can be mitigated with optimum anti-aliasing optical/electrical filters. For example, for PM-QPSK communications having a symbol rate Rs=31.625 GSym/s (127 Gb/s), a potentially optimized anti-aliasing filter combination can be (i) optical filters corresponding to 50 GHz DWDM (e.g., having a BW less than 50 GHz, and SG order larger than 1), and (ii) electrical filters at CMOS speed (analogue BW˜15 GHz, close to Butterworth). As another example, it was described above that for 50 GHz channel spacing at 126 Gb/s, the ADC sampling rate can be reduced from 2× (e.g., 64 GSa/s) to 1.25× (e.g., 40 GSa/s) with less than 0.5 dB penalty even in the case of large (e.g., 23 000 ps/nm) CD noise. In addition, such reduced sampling rate from 2× to 1.25× can provide greater CD tolerance (1.6×) for the same equalizer length (tap number). Thus, a reduced ADC sampling rate of 1.25× can translate in modems having lower gate count and lower power dissipation while having practically the same performance as modems based on ADCs having a sampling rate of 2×.

While this document contains many specifics, these should not be construed as limitations on the scope of any invention or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications and enhancements to the described examples and implementations and other implementations may be made based on what is disclosed and illustrated in this document.

What is claimed is what is disclosed and illustrated, including:

1. An optical receiver comprising:
low-pass filters configured to filter a signal carrying symbols;
an analog-to-digital converter (ADC) operating at a fractional sampling clock rate to convert the filtered signal carrying the symbols to digital ADC output samples;
an interpolator to interpolate at an interpolation clock rate different than the fractional sampling clock rate between digital values derived from said the digital ADC output samples to provide moving interpolations; and
an interpolation feedback loop to synchronize the moving interpolations with the symbols.

2. The receiver of claim 1, wherein:
the fractional sampling clock rate is configured to provide fewer than two of the digital ADC output samples for one of the symbols.

3. The receiver of claim 2, wherein the signal carrying symbols is an incoming optical signal carrying symbols and the low-pass filters include optical filters, the optical receiver further comprising:
a photo-detector arranged down-stream from the optical filters and configured to convert the filtered optical signal carrying the symbols to the filtered signal carrying the symbols,
wherein the optical filters have an optical bandwidth selected to mitigate aliasing caused during said operating the ADC at the fractional sampling clock rate that provides fewer than two of the digital ADC output samples for one of the symbols.

4. The receiver of claim 2, wherein the signal carrying symbols is an electrical signal carrying symbols and the low-pass filters include electrical filters, the optical receiver further comprising:
a photo-detector arranged up-stream from the electrical filters and configured to convert an incoming optical signal carrying the symbols to the signal carrying the symbols,
wherein the electrical filters have an electrical bandwidth selected to mitigate aliasing caused during said operating the ADC at the fractional sampling clock rate that provides fewer than two of the digital ADC output samples for one of the symbols.

5. The receiver of claim 2, wherein the signal carrying symbols is an electrical signal carrying symbols and the low-pass filters include a combination of an optical filter having an optical bandwidth and an electrical filter having an electrical bandwidth, the optical receiver further comprising:
a photo-detector arranged down-stream from the optical filter and up-stream from the electrical filter, the photo-detector being configured to convert a filtered optical signal carrying the symbols to the signal carrying the symbols,
wherein the optical bandwidth and the electrical bandwidth are selected to mitigate aliasing caused during said operating the ADC at the fractional sampling clock rate that provides fewer than two of the digital ADC output samples for one of the symbols.

6. The receiver of claim 1, wherein:
the interpolation clock rate is configured to operate at greater than two times an expected rate of the symbols; and the feedback interpolation loop is configured to synchronize the moving interpolations to two of the moving interpolations for one of the symbols.

7. The receiver of claim 1, wherein:
the interpolation feedback loop includes an accumulator to provide interpolation fractions at the interpolation clock rate, and
the interpolator is configured to use the interpolation fractions to interpolate between the digital values to compute values of the moving interpolations.

8. The receiver of claim 1, further including:
a FIFO to provide the digital values to the interpolator; and
a clocking inhibitor to detect validity of the FIFO and to prevent the interpolator from providing the moving interpolations when the FIFO is not valid.

9. The receiver of claim 1, wherein:
the fractional sampling clock rate is operated at a free running rate not synchronized to the symbols to provide the digital ADC output samples; and
the interpolation feedback loop is configured to provide the moving interpolations synchronized to two of the moving interpolations for one of the symbols.

10. A method comprising:
filtering a signal carrying the symbols using low-pass filters;
converting the filtered signal carrying the symbols to digital ADC output samples at a fractional sampling clock rate;
interpolating at an interpolation clock rate different than the fractional sampling clock rate between digital values derived from the digital ADC output samples to provide moving interpolations; and
synchronizing the moving interpolations with the symbols using feedback from the moving interpolations.

11. The method of claim 10, wherein:
converting the analog signal at the fraction sampling clock rate includes issuing fewer than two of the digital ADC output samples for one of the symbols.

12. The method of claim 11, wherein the signal carrying symbols is an incoming optical signal carrying symbols, the low-pass filters include optical filters, and said filtering includes filtering the incoming optical signal carrying symbols using the optical filters, the method further comprising:
converting the filtered optical signal carrying symbols to the filtered signal carrying symbols,
wherein the optical filters have an optical bandwidth selected to mitigate aliasing caused during said issuing the fewer than two of the digital ADC output samples for one of the symbols.

13. The method of claim 11, wherein the signal carrying symbols is an electrical signal carrying symbols, the low-pass filters include electrical filters, the method further comprising:
converting an incoming optical signal carrying symbols to the electrical signal carrying symbols,
wherein said filtering includes filtering the electrical signal carrying symbols using the electrical filters that have an electrical bandwidth selected to mitigate aliasing caused during said issuing the fewer than two of the digital ADC output samples for one of the symbols.

14. The method of claim 11, wherein the low-pass filters include a combination of an optical filter having an optical bandwidth and an electrical filter having an electrical bandwidth, and said filtering comprises:
filtering an incoming optical system carrying symbols with the optical filter;
converting the filtered optical signal carrying symbols to an electrical signal carrying symbols, and
filtering the electrical signal carrying symbols using the electrical filter to obtain the filtered signal carrying symbols,
wherein the optical bandwidth and the electrical bandwidth are selected to mitigate aliasing caused during said operating the ADC at the fractional sampling clock rate that provides fewer than two of the digital ADC output samples for one of the symbols.

15. The method of claim 10, wherein:
synchronizing includes operating with an interpolation clock rate greater than two times an expected rate of the symbols and synchronizing the moving interpolations with the feedback to two of the moving interpolations for one of the symbols.

16. The method of claim 10, wherein:
interpolating includes providing interpolation fractions at the interpolation clock rate; and using the interpolation fractions for interpolating between the digital values to compute values of the moving interpolations.

17. The method of claim 10, further including:
providing the digital values from a FIFO; and
preventing the interpolating when the FIFO is determined to be not valid.

18. The method of claim 10, further comprising:
operating the fractional sampling clock rate at a free running rate not synchronized to the symbols to provide the digital ADC output samples; and
synchronizing the moving interpolations to two of the moving interpolations to one of the symbols.

19. An optical receiver comprising:
a low-pass optical filter having an optical bandwidth and configured to filter an incoming optical signal carrying symbols into a filtered optical signal carrying symbols;
a photo-detector arranged down-stream from the low-pass optical filter and configured to convert the filtered optical signal carrying symbols into an electrical signal carrying symbols;
a low-pass electrical filter having an electrical bandwidth, the low-pass electrical filter arranged down-stream from the photo-detector and configured to filter the electrical signal carrying symbols into a filtered signal carrying symbols;
an analog-to-digital converter (ADC) arranged down-stream from the electrical low-pass filter, the ADC configured to operate at a fractional sampling clock rate to convert the filtered signal carrying the symbols to digital ADC output samples, wherein the fractional sampling clock rate is configured to provide fewer than two of the digital ADC output samples for one of the symbols;
an interpolator to interpolate at an interpolation clock rate different than the fractional sampling clock rate between digital values derived from said the digital ADC output samples to provide moving interpolations; and
an interpolation feedback loop to synchronize the moving interpolations with the symbols,
wherein the optical bandwidth and the electrical bandwidth are selected to mitigate aliasing caused during operation of the ADC at the fractional sampling clock rate that provides fewer than two of the digital ADC output samples for one of the symbols.
